(19) United States
(12) Patent Application Publication
(10) Pub. No.: US 2011/0065020 A1
(43) Pub. Date: Mar. 17, 2011

(54) PROTON-CONDUCTING MEMBRANE AND ITS USE

(75) Inventors: Oemer Uensal, Mainz (DE); Lucas Montag, Burstadt (DE)

(73) Assignee: BASF SE, Ludwigshafen (DE)

(21) Appl. No.: 12/992,146

(22) PCT Filed: May 2, 2009
(86) PCT No.: PCT/EP09/03163

§ 371 Date: Nov. 11, 2010

(30) Foreign Application Priority Data
May 15, 2008 (EP) 08008975.8

(51) Int. Cl. H01M 8/10

(52) U.S. Cl. 429/492

(57) ABSTRACT

A proton-conducting polymer membrane comprising at least one polyazole, at least one ionic liquid and at least one compound of the formula (P1)

R^{I}₄POH (P1)

wherein R^{I}, in each case mutually independently, is a residue which comprises C, O and/or H optionally together with further atoms differing therefrom, wherein two residues R^{I} may optionally be joined to one another.

The membrane is in particular distinguished by elevated mechanical stability and elevated conductivity and is therefore in particular suitable as a polymer electrolyte membrane for fuel cell applications.

The present invention relates to a novel proton-conducting polymer membrane based on polyazoles, which, thanks to its excellent chemical and thermal properties, may be put to many and varied uses and is in particular suitable as a polymer electrolyte membrane (PEM) in “PEM fuel cells”.

Polymer electrolyte membranes (PEM) are already known and, in particular, are used in fuel cells. Sulfonic acid-modified polymers, in particular perfluorinated polymers, are often used for this purpose. One prominent example of these is Nafion™ from DuPont de Nemours, Willmington USA. Proton conduction entails a relatively high water content in the membrane, typically amounting to 4-20 molecules of water per sulfonic acid group. Not only the necessary water content, but also the stability of the polymer in conjunction with acidic water and the reaction gases hydrogen and oxygen, conventionally limit the operating temperature of the PEM fuel cell stack to 80-100° C. Under pressure, operating temperatures can be raised to >120° C. Otherwise, higher operating temperatures cannot be achieved without a drop in fuel cell performance.

However, for systems engineering reasons, operating temperatures of higher than 100° C. in the fuel cell are desirable. The activity of the noble metal-based catalysts present in the membrane-electrode unit (MEU) is substantially better at elevated operating temperatures. In particular when hydrocarbon “reformates” are used, the reformer gas contains considerable quantities of carbon monoxide which conventionally have to be removed by complex gas preparation or purification. The tolerance of the catalysts to CO contamination increases at elevated operating temperatures.

Furthermore, heat arises during fuel cell operation. However, cooling these systems to below 80° C. may be very demanding. Depending on power output, the cooling devices may be of substantially simpler design. This means that, in fuel cell systems which are operated at temperatures of above 100° C., the waste heat is distinctly more readily utilisable and efficiency of the fuel cell system can be increased by combined heat and power generation.

Membranes with new conductivity mechanisms are generally used to achieve these temperatures. One approach is to use membranes which exhibit proton conductivity without the use of water. The first promising development in this direction is presented in publication WO 96/13872. This in particular proposes using acid-doped polybenzimidazole membranes which are produced by casting.

A further development of this type of membrane is described in WO 02/088219. It teaches the use of proton-conducting polymer membranes based on polyazoles obtainable by a method comprising the steps
A) mixing one or more aromatic tetra-amino compounds with one or more aromatic carboxylic acids or the esters thereof, which contain at least two acid groups per carboxylic acid monomer, or mixing one or more aromatic and/or heteroaromatic diaminocarboxylic acids, in polyphosphoric acid, to form a solution and/or dispersion
B) applying a layer using the mixture according to step A) onto a support,
C) heating the planar structure/layer obtainable according to step B) under inert gas to temperatures of up to 350° C., preferably of up to 280° C., to form the polyazole polymer,
D) treating the membrane formed in step C) until it is self-supporting.

The acid-doped, polyazole-based polymer membranes obtainable in this manner already exhibit a favourable profile of properties. However, in the light of the applications desired for PEM fuel cells, in particular in the automotive sector and decentralised power and heat generation (stationary sector), these properties still require further overall improvement. For instance, such membranes are still relatively soft and can thus be exposed to only limited mechanical loads, with mechanical stability decreasing at higher temperatures, something which may lead to durability problems already in the upper range of the typical operating window (approx. 160° C.-180° C.). It is therefore desirable to improve mechanical properties, in particular membrane stability, while simultaneously maintaining elevated conductivity.

The use of ionic liquids for polymer electrolyte membranes is also known per se. For instance, the publication by R. Scheffler et al. Präparation und Evaluation neuer Hybrid-Protonenleiter—Teil 1: Ionische Flüssigkeiten als Modifikator in Nafion-Hybridmembranen [preparation and evaluation of novel hybrid proton conductors—part 1: ionic liquids as a modifier in Nafion hybrid membranes] Chemie Ingenieur Technik 2007, 79, no. 8, 1175-1182 describes the production and evaluation of Nafion-based hybrid materials as a proton-conducting membrane for fuel cells. A commercial Nafion dispersion was here combined with specific ionic liquids and the respective mixtures homogenised and knife coated. The proton conductivity of the resultant hybrid membranes was characterised by impedance spectroscopy. Although at room temperature the proton conductivity of the ionic liquids as individual substances is below that of Nafion, improvements in proton conductivity were observed for some hybrid materials at higher temperatures.

The publication by T. Greaves et al. Protic Ionic Liquids: Properties and Applications Chem. Rev. 2008, 108, 206-237 discusses the properties and potential applications of protic ionic liquids, i.e. those ionic liquids which are obtained by transfer of a proton from a Brønsted acid onto a Brønsted base. Potential uses in polymer membrane fuel cells are also discussed here.

A drawback of hitherto known polymer electrolyte membranes using ionic liquids is, however, their comparatively low conductivity.

The object of the present invention was accordingly to provide polymer electrolyte membranes with an improved profile of properties. It was here in particular desired to achieve the best possible mechanical properties simultaneously combined with the best possible conductivity characteristics. On the one hand, the membranes should exhibit the applicational advantages of polymer membranes based on polyazoles and, on the other hand, exhibit increased specific conductivity, in particular at operating temperatures of above 100° C. and, if possible, should manage without fuel gas humidification. It should furthermore be possible to produce the membranes comparatively straightforwardly and as inexpensively as possible.

These objects are achieved by a proton-conducting polymer membrane having all the features of claim 1.

The present invention accordingly provides a proton-conducting polymer membrane comprising at least one polyazole, at least one ionic liquid and at least one compound of the formula (P1)

R^{I}₄POH (P1)

wherein R^{I}, in each case mutually independently, is a residue which comprises C, O and/or H optionally together with further atoms differing therefrom, wherein two residues R^{I} may optionally be joined to one another.

The polyazole preferably contains azole repeat units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

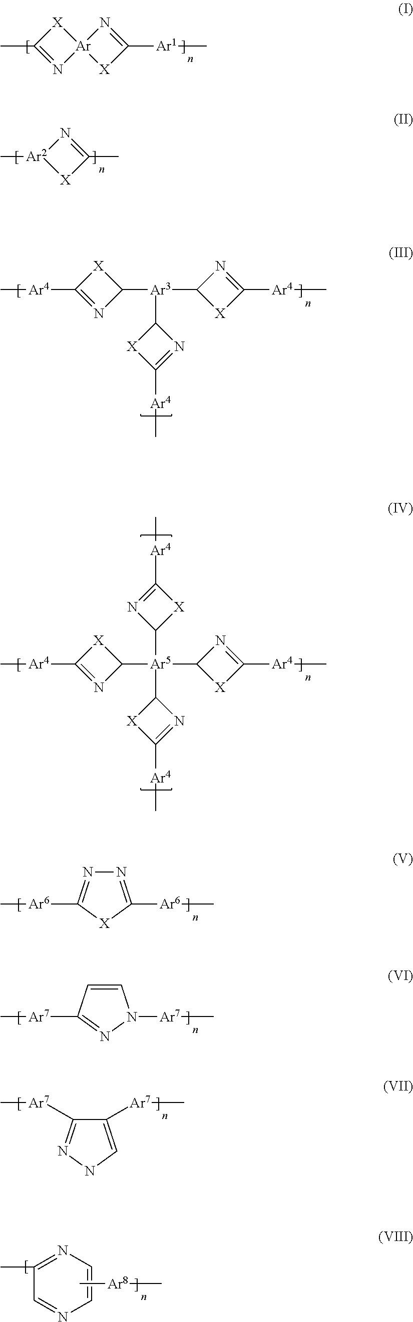

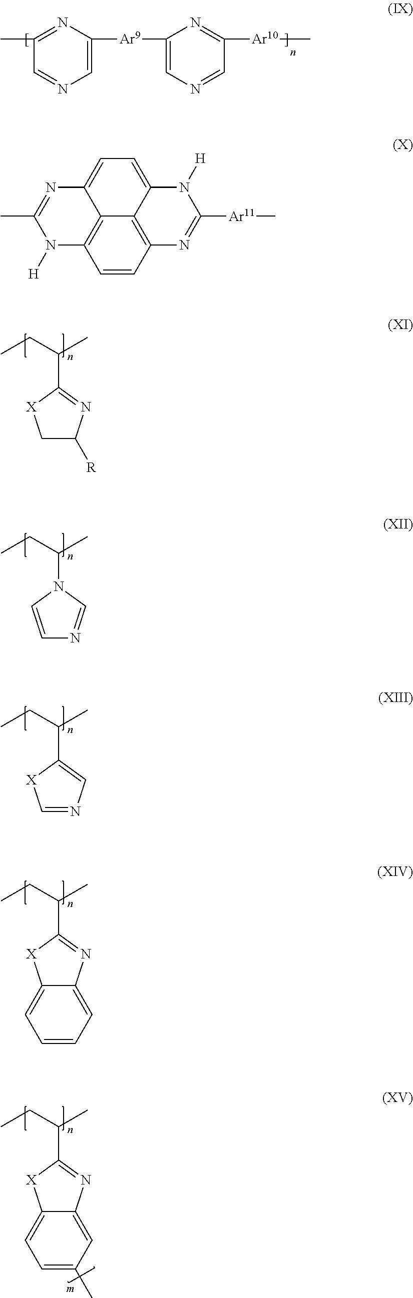

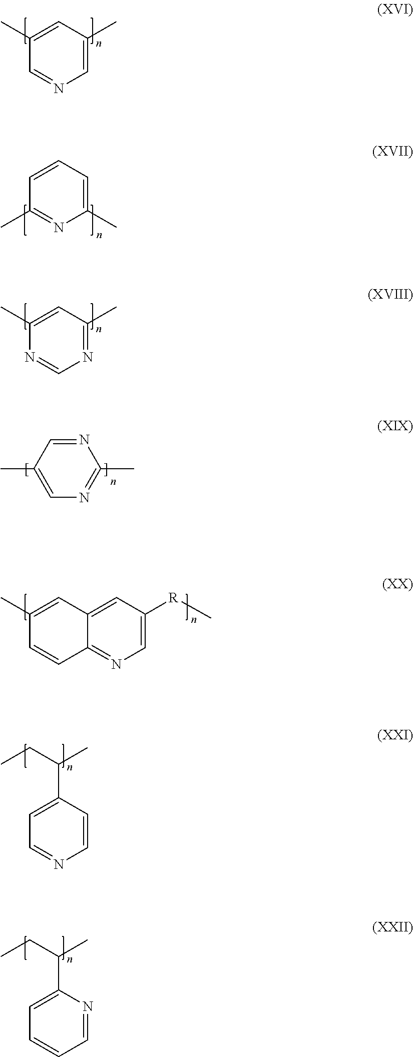

in which

Ar are identical or different and denote a tetravalent aromatic or heteroaromatic group, which may be mono- or polynuclear,

Ar¹ are identical or different and denote a divalent aromatic or heteroaromatic group, which may be mono- or polynuclear,

Ar² are identical or different and denote a di- or trivalent aromatic or heteroaromatic group, which may be mono- or polynuclear,

Ar³ are identical or different and denote a trivalent aromatic or heteroaromatic group, which may be mono- or polynuclear,

Ar⁴ are identical or different and denote a trivalent aromatic or heteroaromatic group, which may be mono- or polynuclear,

Ar⁵ are identical or different and denote a tetravalent aromatic or heteroaromatic group, which may be mono- or polynuclear,

Ar⁶ are identical or different and denote a divalent aromatic or heteroaromatic group, which may be mono- or polynuclear,

Ar⁷ are identical or different and denote a divalent aromatic or heteroaromatic group, which may be mono- or polynuclear,

Ar⁸ are identical or different and denote a trivalent aromatic or heteroaromatic group, which may be mono- or polynuclear,

Ar⁹ are identical or different and denote a di- or tri- or tetravalent aromatic or heteroaromatic group, which may be mono- or polynuclear,

Ar¹⁰ are identical or different and denote a di- or trivalent aromatic or heteroaromatic group, which may be mono- or polynuclear,

Ar¹¹ are identical or different and denote a divalent aromatic or heteroaromatic group, which may be mono- or polynuclear,

X is identical or different and denotes oxygen, sulfur or an amino group, which bears a hydrogen atom, a group comprising 1-20 carbon atoms, preferably a branched or unbranched alkyl or alkoxy group, or an aryl group as a further residue

R in all the formulae apart from formula (XX) identically or differently denotes hydrogen, an alkyl group or an aromatic group and in formula (XX) denotes an alkylene group or an aromatic group and

n, m is an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrrole, pyrazole, anthracene, benzopyrrole, benzotriazole, benzoxathiadiazole, benzoxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may optionally also be substituted.

The substitution pattern of Ar¹, Ar⁴, Ar⁶, Ar⁷, Ar⁸, Ar⁹, Ar¹⁰, Ar¹¹ is here as desired, while in the case of phenylene Ar¹, Ar⁴, Ar⁶, Ar⁷, Ar⁸, Ar⁹, Ar¹⁰, Ar¹¹ may for example be ortho-, meta- and para-phenylene. Particularly preferred groups are derived from benzene and biphenylene, which may optionally also be substituted.

Preferred alkyl groups are short-chain alkyl groups with 1 to 4 carbon atoms, such as for example methyl, ethyl, n- or i-propyl and t-butyl groups.

Preferred aromatic groups are phenyl or naphthyl groups. The alkyl groups and the aromatic groups may be substituted.

Preferred substituents are halogen atoms such as for example fluorine, amino groups, hydroxyl groups or short-chain alkyl groups, such as for example methyl or ethyl groups.

Preferred polyazoles are those with repeat units of the formula (I) in which the residues X are identical within one repeat unit.

The polyazoles may in principle also comprise different repeat units which differ, for example, in their residue X. Preferably, however, only identical residues X are present in one repeat unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In a further embodiment of the present invention, the polyazole is a copolymer which contains at least two units of the formula (I) to (XXII) which differ from one another. The polymers may also assume the form of block copolymers (diblock, triblock), random copolymers, periodic copolymers and/or alternating polymers.

In a particularly preferred embodiment of the present invention, the polyazole is a homopolymer which contains only units of the formula (I) and/or (II).

The number of azole repeat units in the polymer is preferably an integer greater than or equal to 10. Particularly preferred polymers contain at least 100 azole repeat units.

Polymers containing benzimidazole repeat units are preferred for the purposes of the present invention. Some examples of the highly appropriate polymers containing benzimidazole repeat units are represented by the following formulae:

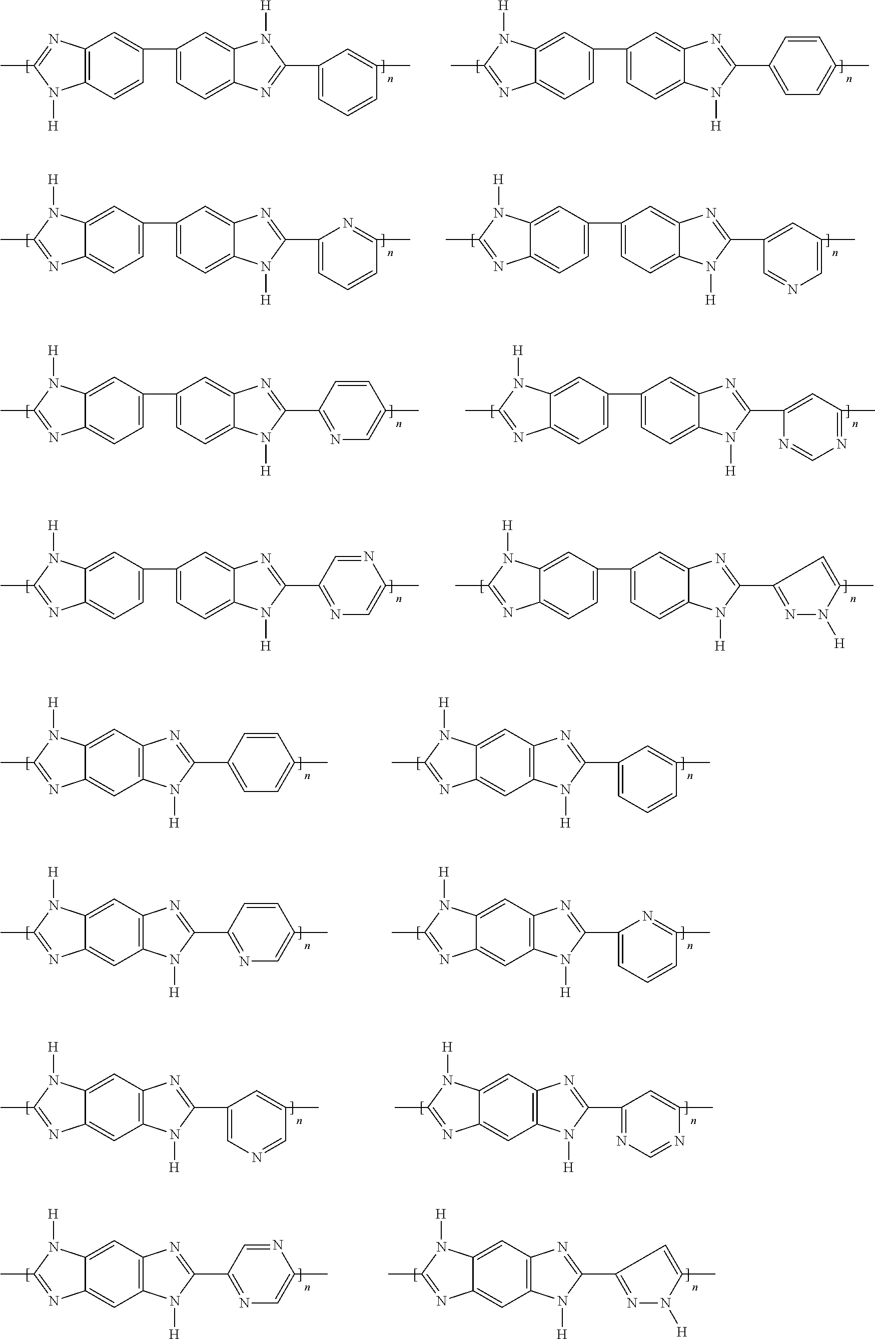

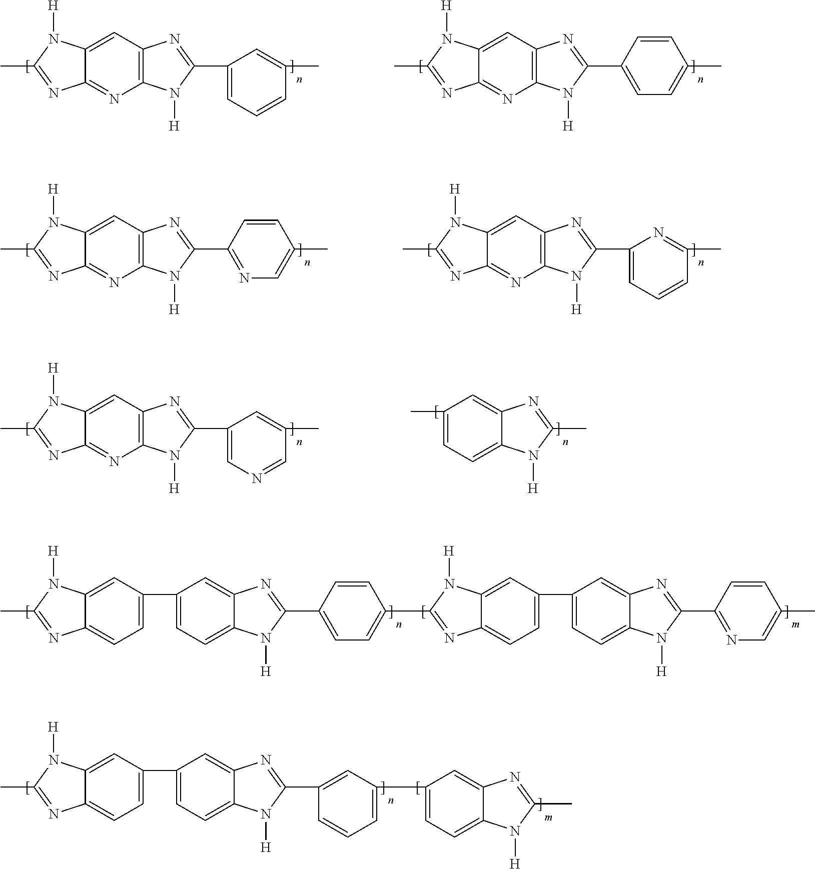

wherein n and m are integers greater than or equal to 10, preferably greater than or equal to 100.

For the purposes of a particularly preferred variant of the present invention, the polyazoles comprise at least one sulfonic and/or phosphonic acid group. Such polymers are described in document DE 102 46 459 A1, the disclosure of which is hereby incorporated by reference.

The polyazoles used, but in particular the polybenzimidazoles, are distinguished by an elevated molecular weight. Measured as intrinsic viscosity, this amounts to at least 0.2 dl/g, preferably 0.8 to 10 dl/g, in particular 1 to 10 dl/g.

Preferred polybenzimidazoles are commercially available under the trade name ®Celazole.

In addition to the polyazole, the proton-conducting polymer membrane of the present invention furthermore contains at least one ionic liquid. These should be taken to mean those substances which solely contain ions and thus assume the form of liquid salts, without the salt being dissolved in a solvent such as water.

Ionic liquids for the purposes of the present invention are preferably salts of the general formula
(A) salts of the general formula (IL-I)
B) [A]ₙ⁺[Y]ⁿ⁻ (IL-I),
C) in which n denotes 1, 2, 3 or 4, [A]⁺ denotes a quaternary ammonium cation, an oxonium cation, a sulfonium cation or a phosphonium cation and [Y]ⁿ⁻ denotes a mono-, di-, tri- or tetravalent anion;

mixed salts of the general formulae (IL-II)
A) [A¹]⁺[A²]⁺[Y]ⁿ⁻ (IL-IIa), wherein n=2;
B) [A¹]⁺[A²]⁺[A³]⁺[Y]ⁿ⁻ (IL-IIb), wherein n=3; or
C) [A¹]⁺[A²]⁺[A³]⁺[A⁴]⁺[Y]ⁿ⁻ (IL-IIc), wherein n=4 and
D) wherein [A¹]⁺, [A²]⁺, [A³]⁺ and [A⁴]⁺ are mutually independently selected from the groups stated for [A]⁺ and [Y]ⁿ⁻ has the meaning stated in (A); or

mixed salts of the general formulae (IL-III)
A) [A¹]⁺[A²]⁺[A³]⁺[M¹]⁺[Y]ⁿ⁻ (IL-IIIa), wherein n=4;
B) [A¹]⁺[A²]⁺[M¹]⁺[M²]⁺[Y]ⁿ⁻ (IL-IIIb), wherein n=4;
C) [A¹]⁺[M¹]⁺[M²]⁺[M³]⁺[Y]ⁿ⁻ (IL-IIIc), wherein n=4;
D) [A¹]⁺[A²]⁺[M¹]⁺[Y]ⁿ⁻ (IL-IIId), wherein n=3;
E) [A¹]⁺[M¹]⁺[M²]⁺[Y]ⁿ⁻ (IL-IIIe), wherein n=3;
F) [A¹]⁺[M¹]⁺[Y]ⁿ⁻ (IL-IIIf), wherein n=2;
G) [A¹]⁺[A²]⁺[M⁴]²⁺[Y]ⁿ⁻ (IL-IIIg), wherein n=4;
H) [A¹]⁺[M¹]⁺[M⁴]²⁺[Y]ⁿ⁻ (IL-IIIh), wherein n=4;
I) [A1]⁺[M⁵]³⁺[Y]ⁿ⁻ (IL-IIIi), wherein n=4; or
J) [A¹]⁺[M⁴]²⁺[Y]ⁿ⁻ (IL-IIIj), wherein n=3 and
K) wherein [A¹]⁺, [A²]⁺ and [A³]⁺ are mutually independently selected from the groups stated for [A]⁺, [Y]ⁿ⁻ has the meaning stated in (A) and [M¹]⁺, [M²]⁺, [M³]⁺ mean monovalent metal cations, [M⁴]²⁺ means divalent metal cations and [M⁵]³⁺ means trivalent metal cations.

The ionic liquids preferably have a melting point of less than 180° C. The melting point is furthermore preferably in a range from −50° C. to 150° C., more preferably in the range from −20° C. to 120° C. and still more preferably below 100° C. The melting point may here be measured using a manner known per se. The dynamic differential calorimetry (DSC) method, in particular using a heating rate of 10 K/min, has proved particularly effective.

The ionic liquids according to the invention are organic compounds, i.e. at least one cation or anion of the ionic liquid contains an organic residue.

Compounds which are suitable for forming the cation [A]⁺ of ionic liquids are known, for example, from DE 102 02 838 A1. Such compounds may accordingly contain oxygen, phosphorus, sulfur or in particular nitrogen atoms, for example at least one nitrogen atom, preferably 1-10 nitrogen atoms, particularly preferably 1-5, very particularly preferably 1-3 and in particular 1-2 nitrogen atoms. Further heteroatoms such as oxygen, sulfur or phosphorus atoms may optionally also be present. The nitrogen atom is a suitable positive charge carrier in the ionic liquid cation, from which, at equilibrium, a proton or an alkyl residue may transfer onto the anion in order to produce an electrically neutral molecule.

In the event that the nitrogen atom is the positive charge carrier in the cation of the ionic liquid, a cation may be produced during synthesis of the ionic liquids by initially quaternising for instance an amine or nitrogen heterocycle on the nitrogen atom. Quaternisation may proceed by alkylation of the nitrogen atom. Depending on the alkylating reagent used, salts with different anions are obtained. In those cases in which it is not possible already to form the desired anion during quaternisation, this may proceed in a further synthesis step. For example, starting from an ammonium halide, the halide may be reacted with a Lewis acid, a complex anion being formed from the halide and Lewis acid. Alternatively, a halide ion may be replaced with the desired anion. This may proceed by adding a metal salt with precipitation of the resultant metal halide, by means of an ion exchanger or by displacing the halide ion by a strong acid (with liberation of the hydrohalic acid). Suitable methods are described, for example, in Angew. Chem. 2000, 112, p. 3926-3945 and the literature cited therein.

Suitable alkyl residues with which the nitrogen atom in the amines or nitrogen heterocycles may for example be quaternised are C₁-C₁₈ alkyl, preferably C₁-C₁₀ alkyl, particularly preferably C₁-C₆ alkyl and very particularly preferably methyl. The alkyl group may be unsubstituted or comprise one or more identical or different substituents.

Preferred compounds are those which contain at least one five- to six-membered heterocycle, in particular a five-membered heterocycle, which comprises at least one nitrogen atom and optionally an oxygen or sulfur atom; particularly preferred compounds are those which contain at least one five- to six-membered heterocycle which comprises one, two or three nitrogen atoms and a sulfur or an oxygen atom; very particularly preferred compounds are those having two nitrogen atoms. Aromatic heterocycles are furthermore preferred.

Particularly preferred compounds are those which have a molecular weight of below 1000 g/mol, very particularly preferably of below 500 g/mol.

Preferred cations are furthermore those which are selected from compounds of the formulae (IL-IVa) to (IL-IVw),

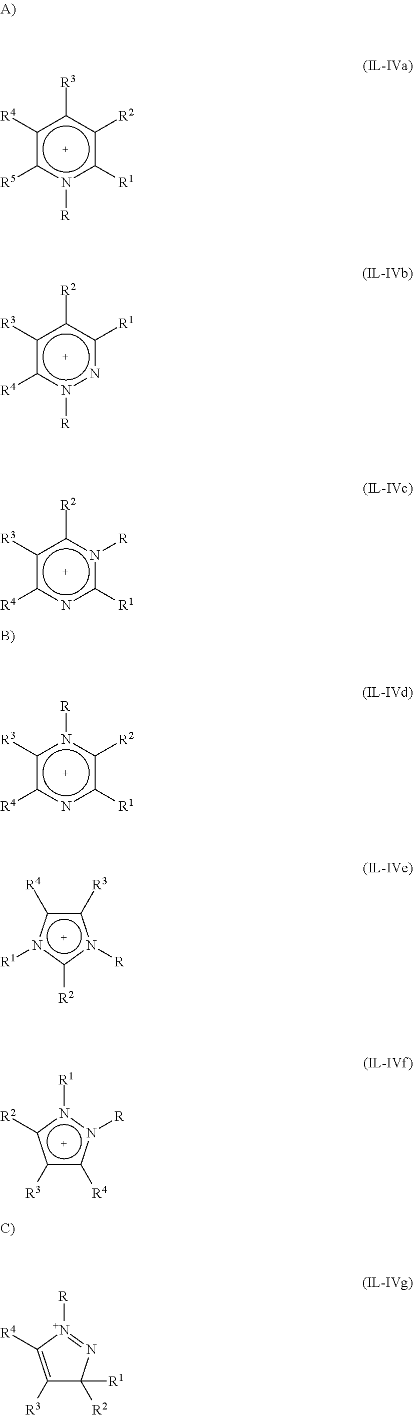

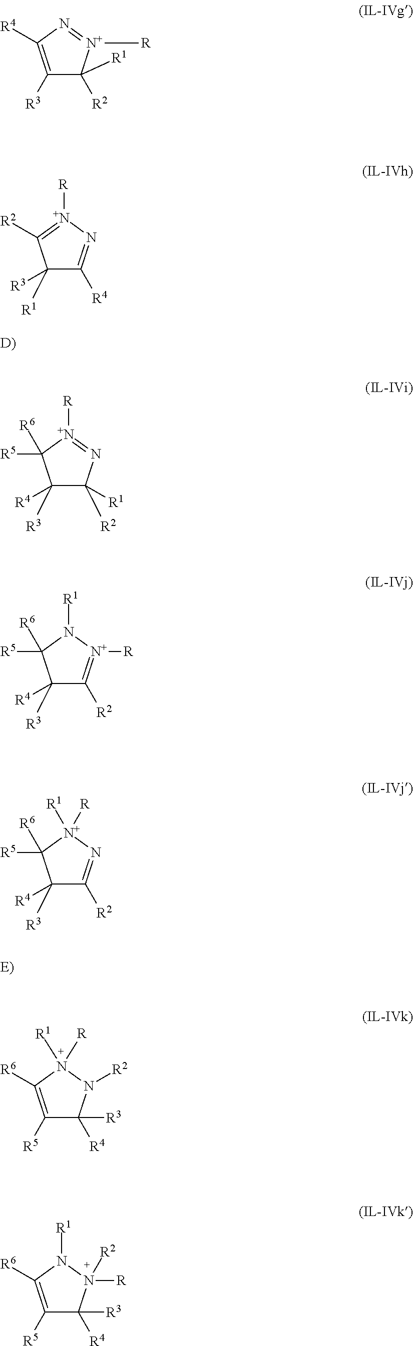

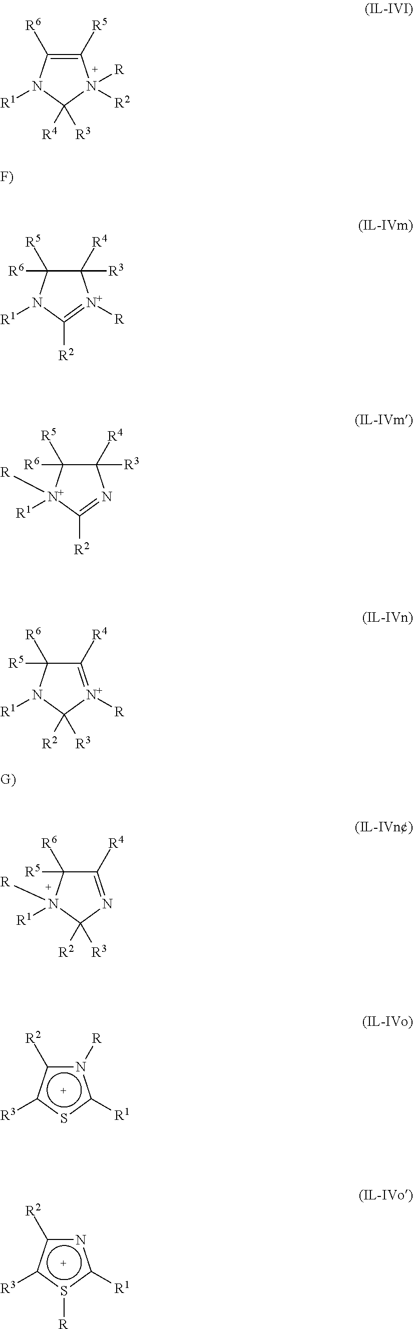

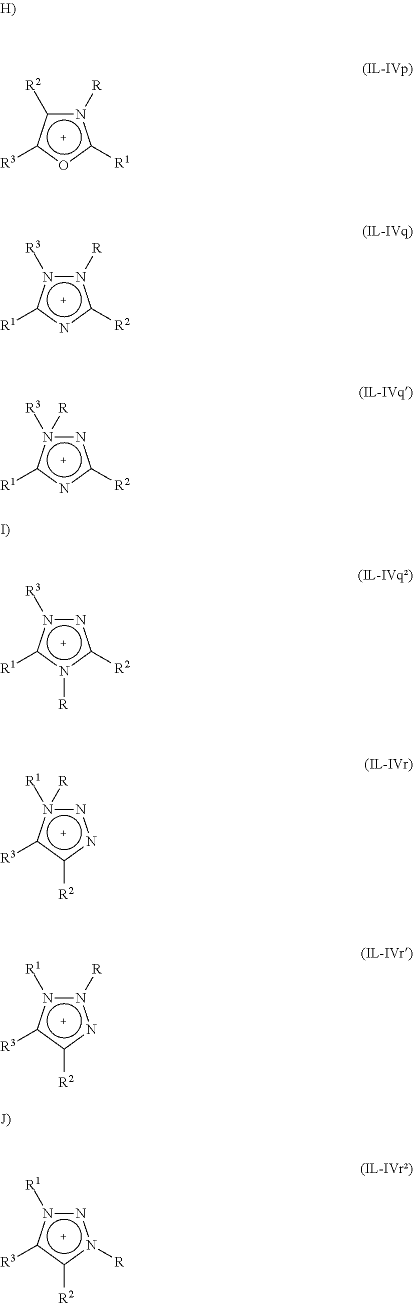

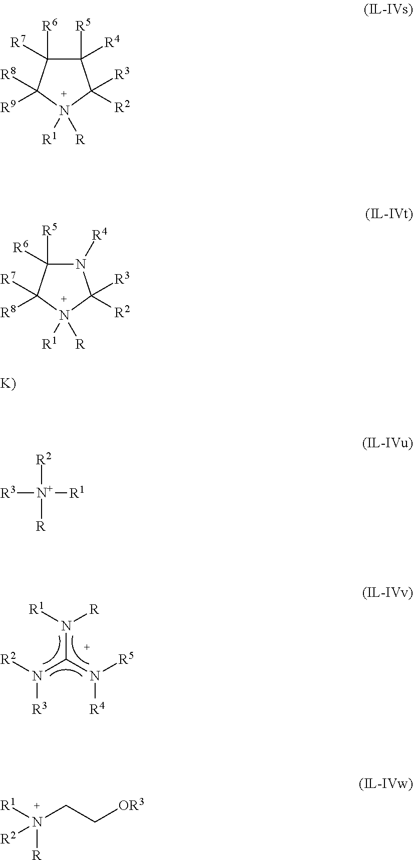

together with oligomers which contain these structures.

Further suitable cations are compounds of the general formula (IL-IVx) and (IL-IVy)

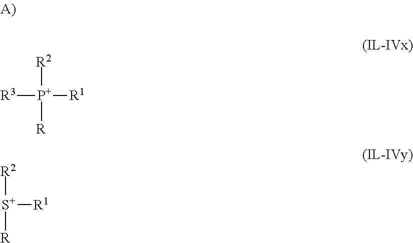

together with oligomers which contain this structure.

In the above-stated formulae (IL-IVa) to (IL-IVy)

the residue R denotes hydrogen, a carbon-containing organic, saturated or unsaturated, acyclic or cyclic, aliphatic, aromatic or araliphatic residue with 1 to 20 carbon atoms which is unsubstituted or interrupted or substituted by 1 to 5 heteroatoms or functional groups; and

the residues R¹ to R⁹ mutually independently denote hydrogen or a carbon-containing organic, saturated or unsaturated, acyclic or cyclic, aliphatic, aromatic or araliphatic residue with 1 to 20 carbon atoms which is unsubstituted or interrupted or substituted by 1 to 5 heteroatoms or functional groups, wherein the residues R¹ to R⁹, which in the above-stated formulae (IL-IV) are attached to a carbon atom (and not to a heteroatom), may additionally also denote F or a functional group; or
A) two adjacent residues from the series R¹ to R⁹ together also denote a divalent, carbon-containing organic, saturated or unsaturated, acyclic or cyclic, aliphatic, aromatic or araliphatic residue with 1 to 30 carbon atoms which is unsubstituted or interrupted or substituted by 1 to 5 heteroatoms or functional groups.

Heteroatoms which may be considered in the definition of residues R and R¹ to R⁹ are in principle any heteroatoms which are capable of formally replacing a —CH₂—, a —CH═, a —C≡ or a ═C═-group. If the carbon-containing residue contains heteroatoms, oxygen, nitrogen, sulfur, phosphorus and silicon are preferred. Preferred groups which may in particular be mentioned are —O—, —SO—, —SO₂—, —NR′—, —N═, —PR′—, —PR′₂ and —SiR′₂—, wherein the residues R′ comprise the remaining part of the carbon-containing residue. In those cases in which the residues R¹ to R⁹ in the above-stated formulae (IL-IV) are attached to a carbon atom (and not to a heteroatom), they may also be attached directly via the heteroatom.

Functional groups which may in principle be considered are any functional groups which may be attached to a carbon atom or a heteroatom. Suitable examples which may be mentioned are —OH (hydroxy), ═O (in particular as a carbonyl group), —NH₂ (amino), —NHR′, —NR₂′═NH (imino), —COON (carboxy), —CONH₂ (carboxamide), —SO₃H, (sulfo) and —CN (cyano). Functional groups and heteroatoms may also be directly adjacent, such that combinations of two or more adjacent atoms, such as for instance —O— (ether), —COO— (ester), —CONN— (secondary amide) or —CONR′— (tertiary amide), are also included, for example di-(C₁-C₄-alkyl)-amino, C₁-C₄ alkyloxycarbonyl or C₁-C₄ alkyloxy. The residues R′ comprise the remaining part of the carbon-containing residue.

The residue R preferably denotes

unbranched or branched C₁-C₁₈ alkyl having a total of 1 to 20 carbon atoms which is unsubstituted or mono- or polysubstituted with hydroxy, halogen, phenyl, cyano, C₁-C₆ alkoxycarbonyl and/or SO₃H, such as for example methyl, ethyl, 1-propyl, 2-propyl, 1-butyl, 2-butyl, 2-methyl-1-propyl(isobutyl), 2-methyl-2-propyl (tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-hydroxyethyl, 2-cyanoethyl, 2-(methoxycarbonyl)-ethyl, 2-(ethoxycarbonyl)-ethyl, 2-(n-butoxycarbonyl)-ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;

glycols, butylene glycols and the oligomers thereof with 1 to 100 units and a hydrogen or a C₁-C₈ alkyl as end group, such as for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— with R^{A} and R^{B} preferably hydrogen, methyl or ethyl and n preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;

vinyl;

1-propen-1-yl, 1-propen-2-yl and 1-propen-3-yl; and

N,N-di-C₁-C₆-alkylamino, such as for example N,N-dimethylamino and N,N-diethylamino.

The residue R particularly preferably denotes unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl and denotes CH₃O—(CH₂CH₂O)ₙ—CH₂CH₂— and CH₃CH₂O—(CH₂CH₂O)ₙ—CH₂CH₂— with n equal to 0 to 3.

The residues R¹ to R⁹ preferably mutually independently denote

hydrogen;

F;

a functional group;

C₁-C₁₈ alkyl optionally substituted by functional groups, aryl, alkyl, aryloxy, alkyloxy, F, heteroatoms and/or heterocycles and/or interrupted by one or more oxygen atoms and/or one or more substituted or unsubstituted imino groups;

C₂-C₁₈ alkenyl optionally substituted by functional groups, aryl, alkyl, aryloxy, alkyloxy, F, heteroatoms and/or heterocycles and/or interrupted by one or more oxygen atoms and/or one or more substituted or unsubstituted imino groups;

C₆-C₁₂ aryl optionally substituted by functional groups, aryl, alkyl, aryloxy, alkyloxy, F, heteroatoms and/or heterocycles;

C₅-C₁₂ cycloalkyl optionally substituted by functional groups, aryl, alkyl, aryloxy, alkyloxy, F, heteroatoms and/or heterocycles;

C₅-C₁₂ cycloalkenyl optionally substituted by functional groups, aryl, alkyl, aryloxy, alkyloxy, F, heteroatoms and/or heterocycles; or

a five- to six-membered heterocycle comprising oxygen and/or nitrogen atoms optionally substituted by functional groups, aryl, alkyl, aryloxy, alkyloxy, F, heteroatoms and/or heterocycles; or

two adjacent residues together with the atoms to which they are attached denote

an unsaturated, saturated or aromatic ring optionally substituted by functional groups, aryl, alkyl, aryloxy, alkyloxy, F, heteroatoms and/or heterocycles and optionally interrupted by one or more oxygen atoms and/or one or more substituted or unsubstituted imino groups.

C₁-C₁₈ alkyl optionally substituted by functional groups, aryl, alkyl, aryloxy, alkyloxy, F, heteroatoms and/or heterocycles preferably comprises methyl, ethyl, 1-propyl, 2-propyl, 1-butyl, 2-butyl, 2-methyl-1-propyl (isobutyl), 2-methyl-2-propyl (tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)-ethyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)-ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxy-butyl, 6-methoxyhexyl, 2-ethoxyethyl, 2-ethoxypropyl, 3-ethoxypropyl, 4-ethoxybutyl, 6-ethoxyhexyl, acetyl, CₙF_{2(n-a)+(1-b)}H_{2a+b} with n equal to 1 to 30, 0≦a≦n and b=0 or 1 (for example CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅), methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)-ethyl, 2-(ethoxycarbonyl)-ethyl, 2-(n-butoxycarbonyl)-ethyl, butylthiomethyl, 2-dodecylthio-ethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈ alkenyl optionally substituted by functional groups, aryl, alkyl, aryloxy, alkyloxy, F, heteroatoms and/or heterocycles and/or interrupted by one or more oxygen atoms and/or one or more substituted or unsubstituted imino groups preferably comprises vinyl, 2-propenyl, 3-butenyl, cis-2-butenyl, trans-2-butenyl or CₙF_{2(n-a)-(1-b)}H_{2a-b} with n≦30, 0≦a≦n and b=0 or 1.

C₆-C₁₂ aryl optionally substituted by functional groups, aryl, alkyl, aryloxy, alkyloxy, F, heteroatoms and/or heterocycles preferably comprises phenyl, tolyl, xylyl, α-naphthyl, β-naphthyl, 4-diphenylyl, difluorophenyl, methylphenyl, dimethylphenyl, trimethylphenyl, ethylphenyl, diethylphenyl, iso-propylphenyl, tert.-butylphenyl, dodecylphenyl, methoxyphenyl, dimethoxyphenyl, ethoxyphenyl, hexyloxyphenyl, methylnaphthyl, isopropylnaphthyl, ethoxynaphthyl, 2,6-dimethylphenyl, 2,4,6-trimethylphenyl, 2,6-dimethoxyphenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl or C₆F₍₅₋ₐ₎Hₐ with 0≦a≦5.

C₅-C₁₂ cycloalkyl optionally substituted by functional groups, aryl, alkyl, aryloxy, alkyloxy, F, heteroatoms and/or heterocycles preferably comprises cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, CₙF_{2(n-a)-(1-b)}H_{2a-b} with n≦30, 0≦a≦n and b=0 or 1 and a saturated or unsaturated bicyclic system such as for example norbornyl or norbornenyl.

C₅-C₁₂ cycloalkenyl optionally substituted by functional groups, aryl, alkyl, aryloxy, alkyloxy, F, heteroatoms and/or heterocycles preferably comprises 3-cyclopentenyl, 2-cyclohexenyl, 3-cyclohexenyl, 2,5-cyclohexadienyl or CₙF_{2(n-a)-3(1-b)}H_{2a-3b} with n≦30, 0≦a≦n and b=0 or 1.

A five- to six-membered heterocycle comprising oxygen and/or nitrogen atoms optionally substituted by functional groups, aryl, alkyl, aryloxy, alkyloxy, F, heteroatoms and/or heterocycles preferably comprises furyl, pyrryl, pyridyl, indolyl, benzoxazolyl, dioxolyl, dioxyl, benzimidazolyl, dimethylpyridyl, methylquinolyl, dimethylpyrryl, methoxyfuryl, dimethoxypyridyl or difluoropyridyl.

If two adjacent residues together form an unsaturated, saturated or aromatic ring optionally substituted by functional groups, aryl, alkyl, aryloxy, alkyloxy, F, heteroatoms and/or heterocycles and optionally interrupted by one or more oxygen atoms and/or one or more substituted or unsubstituted imino groups, this preferably involves 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the above-stated residues contain oxygen atoms and/or substituted or unsubstituted imino groups, the number of oxygen atoms and/or imino groups is unlimited. In general, the number amounts to no more than 5 in the residue, preferably no more than 4 and very particularly preferably no more than 3.

If the above-stated residues contain heteroatoms, in general at least one carbon atom, preferably at least two carbon atoms, is/are located between two heteroatoms.

The residues R¹ to R⁹ particularly preferably mutually independently denote

hydrogen;

unbranched or branched C₁-C₁₈ alkyl having a total of 1 to 20 carbon atoms which is unsubstituted or mono- or polysubstituted with hydroxy, F, phenyl, cyano, C₁-C₆ alkoxycarbonyl and/or SO₃H, such as for example methyl, ethyl, 1-propyl, 2-propyl, 1-butyl, 2-butyl, 2-methyl-1-propyl (isobutyl), 2-methyl-2-propyl (tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-hydroxyethyl, 2-cyanoethyl, 2-(methoxycarbonyl)-ethyl, 2-(ethoxycarbonyl)-ethyl, 2-(n-butoxycarbonyl)-ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;

glycols, butylene glycols and the oligomers thereof with 1 to 100 units and a hydrogen or a C₁-C₈ alkyl as end group, such as for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— with R^{A} and R^{B} preferably hydrogen, methyl or ethyl and n preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;

vinyl;

1-propen-1-yl, 1-propen-2-yl and 1-propen-3-yl; and

N,N-di-C₁-C₆-alkylamino, such as for example N,N-dimethylamino and N,N-diethylamino.

The residues R¹ to R⁹ very particularly preferably mutually independently denote hydrogen or C₁-C₁₈ alkyl, such as for example methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino and CH₃O—(CH₂CH₂O)ₙ—CH₂CH₂— and CH₃CH₂O—(CH₂CH₂O)ₙ—CH₂CH₂— with n equal to 0 to 3.

The pyridinium ions (IL-IVa) used are very particularly preferably those in which

one of residues R¹ to R⁵ is methyl or ethyl and the remaining residues R¹ to R⁵ are hydrogen;

R³ is dimethylamino and the remaining residues R¹, R², R⁴ and R⁵ are hydrogen;

all residues R¹ to R⁵ are hydrogen;

R² is carboxy or carboxamide and the remaining residues R¹, R², R⁴ and R⁵ are hydrogen; or

R¹ and R² or R² and R³ are 1,4-buta-1,3-dienylene and the remaining residues R¹, R², R⁴ and R⁵ are hydrogen;

and in particular those in which

R¹ to R⁵ are hydrogen; or

one of residues R¹ to R⁵ is methyl or ethyl and the remaining residues R¹ to R⁵ are hydrogen.

Very particularly preferred pyridinium ions (IL-IVa) which may be mentioned are 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)-pyridinium, 1-(1-tetradecyl)-pyridinium, 1-(1-hexadecyl)-pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

The pyridazinium ions (IL-IVb) used are very particularly preferably those in which

R¹ to R⁴ are hydrogen; or

one of residues R¹ to R⁴ is methyl or ethyl and the remaining residues R¹ to R⁴ are hydrogen.

The pyrimidinium ions (IL-IVc) used are very particularly preferably those in which

R¹ is hydrogen, methyl or ethyl and R² to R⁴ are mutually independently hydrogen or methyl; or

R¹ is hydrogen, methyl or ethyl, R² and R⁴ are methyl and R³ is hydrogen.

The pyrazinium ions (IL-IVd) used are very particularly preferably those in which

R¹ is hydrogen, methyl or ethyl and R² to R⁴ are mutually independently hydrogen or methyl;

R¹ is hydrogen, methyl or ethyl, R² and R⁴ are methyl and R³ is hydrogen;

R¹ to R⁴ are methyl; or

R¹ to R⁴ are hydrogen.

The imidazolium ions (IL-IVe) used are very particularly preferably those in which

R¹ is hydrogen, methyl, ethyl, 1-propyl, 1-butyl, 1-pentyl, 1-hexyl, 1-octyl, 2-hydroxyethyl or 2-cyanoethyl and R² to R⁴ are mutually independently hydrogen, methyl or ethyl.

Very particularly preferred imidazolium ions (IL-IVe) which may be mentioned are 1-methylimidazolium, 1-ethylimidazolium, 1-(1-butyl)-imidazolium, 1-(1-octyl)-imidazolium, 1-(1-dodecyl)-imidazolium, 1-(1-tetradecyl)-imidazolium, 1-(1-hexadecyl)-imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

The pyrazolium ions (IL-IVf), (IL-IVg) or (IL-IVg′) used are very particularly preferably those in which

R¹ is hydrogen, methyl or ethyl and R² to R⁴ are mutually independently hydrogen or methyl.

The pyrazolium ions (IL-IVh) used are very particularly preferably those in which

R¹ to R⁴ are mutually independently hydrogen or methyl.

The 1-pyrazolinium ions (IL-IVi) used are very particularly preferably those in which

R¹ to R⁶ are mutually independently hydrogen or methyl.

The 2-pyrazolinium ions (IL-IVj) or (IL-IVj′) used are very particularly preferably those in which

R¹ is hydrogen, methyl, ethyl or phenyl and R² to R⁶ are mutually independently hydrogen or methyl.

The 3-pyrazolinium ions (IL-IVk) or (IL-IVk′) used are very particularly preferably those in which

R¹ and R² are mutually independently hydrogen, methyl, ethyl or phenyl and R³ to R⁶ are mutually independently hydrogen or methyl.

The imidazolinium ions (IL-IVl) used are very particularly preferably those in which

R¹ and R² are mutually independently hydrogen, methyl, ethyl, 1-butyl or phenyl, R³ and R⁴ are mutually independently hydrogen, methyl or ethyl and R⁵ and R⁶ are mutually independently hydrogen or methyl.

The imidazolinium ions (IL-IVm) or (IL-IVm′) used are very particularly preferably those in which

R¹ and R² are mutually independently hydrogen, methyl or ethyl and R³ to R⁶ are mutually independently hydrogen or methyl.

The imidazolinium ions (IL-IVn) or (IL-IVn′) used are very particularly preferably those in which

R¹ to R³ are mutually independently hydrogen, methyl or ethyl and R⁴ to R⁶ are mutually independently hydrogen or methyl.

The thiazolium ions (IL-IVo) or (IL-IVo′) used and the oxazolium ions (IL-IVp) used are very particularly preferably those in which

R¹ is hydrogen, methyl, ethyl or phenyl and R² and R³ are mutually independently hydrogen or methyl.

The 1,2,4-triazolium ions (IL-IVq), (IL-IVq′) or (IL-IVq″) used are very particularly preferably those in which

R¹ and R² are mutually independently hydrogen, methyl, ethyl or phenyl and R³ is hydrogen, methyl or phenyl.

The 1,2,3-triazolium ions (IL-IVr), (IL-IVr′) or (IL-IVr″) used are very particularly preferably those in which

R¹ is hydrogen, methyl or ethyl and R² and R³ are mutually independently hydrogen or methyl, or R² and R³ are together 1,4-buta-1,3-dienylene.

The pyrrolidinium ions (IL-IVs) used are very particularly preferably those in which

R¹ is hydrogen, methyl, ethyl or phenyl and R² to R⁹ are mutually independently hydrogen or methyl.

The imidazolidinium ions (IL-IVt) used are very particularly preferably those in which

R¹ and R⁴ are mutually independently hydrogen, methyl, ethyl or phenyl and R² and R³ and R⁵ to R⁸ are mutually independently hydrogen or methyl.

The ammonium ions (IL-IVu) used are very particularly preferably those in which

R¹ to R³ are mutually independently C₁ to C₁₈ alkyl; or

R¹ and R² are together 1,5-pentylene or 3-oxa-1,5-pentylene and R³ is C₁-C₁₈ alkyl, 2-hydroxyethyl or 2-cyanoethyl.

Very particularly preferred ammonium ions (IL-IVu) which may be mentioned are methyltri-(1-butyl)-ammonium, N,N-dimethylpiperidinium and N,N-dimethylmorpholinium.

Examples of tertiary amines from which the quaternary ammonium ions of the general formula (IL-IVu) are derived by quaternisation with the stated residues R are diethyl-n-butylamine, diethyl-tert.-butylamine, diethyl-n-pentylamine, diethylhexylamine, diethyloctylamine, diethyl-(2-ethylhexyl)-amine, di-n-propylbutyl-amine, di-n-propyl-n-pentylamine, di-n-propylhexylamine, di-n-propyloctylamine, di-n-propyl-(2-ethylhexyl)-amine, diisopropylethylamine, diisopropyl-n-propylamine, diisopropylbutylamine, diisopropylpentylamine, diisopropylhexylamine, diisopropyloctylamine, diisopropyl-(2-ethylhexyl)-amine, di-n-butylethylamine, di-n-butyl-n-propylamine, di-n-butyl-n-pentylamine, di-n-butylhexylamine, di-n-butyloctyl-amine, di-n-butyl-(2-ethylhexyl)-amine, N-n-butylpyrrolidine, N-sec.-butylpyrrolidine, N-tert.-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-iso-propylpiperidine, N-n-butylpiperidine, N-sec.-butylpiperidine, N-tert.-butylpiperidine, N-n-pentylpiperidine, N-n-butylmorpholine, N-sec.-butylmorpholine, N-tert.-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenyl-amine and di-n-butylphenylamine.

Preferred quaternary ammonium salts of the general formula (IL-IVu) are those which may be derived from the following tertiary amines by quaternisation with the stated residues R, such as diisopropylethylamine, diethyl-tert.-butylamine, diisopropylbutylamine, di-n-butyl-n-pentylamine, N,N-di-n-butylcyclohexylamine, together with tertiary amines from pentyl isomers.

Particularly preferred tertiary amines are di-n-butyl-n-pentylamine and tertiary amines from pentyl isomers. A further preferred tertiary amine which comprises three identical residues is triallylamine.

The guanidinium ions (IL-IVv) used are very particularly preferably those in which

R¹ to R⁵ are methyl.

A very particularly preferred guanidinium ion (IL-IVv) which may be mentioned is N,N,N′,N′,N″,N″-hexaethylguanidinium.

The cholinium ions (IL-IVw) used are very particularly preferably those in which

R¹ and R² are mutually independently methyl, ethyl, 1-butyl or 1-octyl and R³ is hydrogen, methyl, ethyl, acetyl, —SO₂—OH or —PO(—OH)₂;

R¹ is methyl, ethyl, 1-butyl or 1-octyl, R² is a —CH₂—CH₂—OR⁴ group and R³ and R⁴ are mutually independently hydrogen, methyl, ethyl, acetyl, —SO₂OH or —PO(OH)₂; or

R¹ is a —CH₂—CH₂—OR⁴ group, R² is a —CH₂—CH₂—OR⁵ group and R³ to R⁵ are mutually independently hydrogen, methyl, ethyl, acetyl, —SO₂OH or —PO(OH)₂.

Particularly preferred cholinium ions (IL-IVw) are those in which R³ is selected from hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

The phosphonium ions (IL-IVx) used are very particularly preferably those in which

R¹ to R³ are mutually independently C₁-C₁₈ alkyl, in particular butyl, isobutyl, 1-hexyl or 1-octyl.

Preferred cations among the above-stated heterocyclic cations are pyridinium ions, pyrazolinium and pyrazolium ions and imidazolinium and imidazolium ions. Ammonium ions are furthermore preferred.

In particular, the following are preferred: 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)-pyridinium, 1-(1-tetradecyl)-pyridinium, 1-(1-hexadecyl)-pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)-imidazolium, 1-(1-tetradecyl)-imidazolium, 1-(1-hexadecyl)-imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

The metal cations stated in the formulae (IIIa) to (IIIj) [M¹]⁺, [M²]⁺, [M³]⁺, [M⁴]²⁺ and [M⁵]³⁺ generally comprise metal cations from groups 1, 2, 6, 7, 8, 9, 10, 11, 12 and 13 of the periodic table of elements. Suitable metal cations are for example Li⁺, Na⁺, K⁺, Cs⁺ and Ag⁺.

Any anions may in principle be used as the anions.

The anion [Y]ⁿ⁻ of the ionic liquid is for example selected from

F⁻

the group of sulfates, sulfites and sulfonates of the general formula:

SO₄²⁻, HSO₄⁻, SO₃²⁻, HSO₃⁻, R^{a}OSO₃⁻, R^{a}SO₃⁻

the group of phosphates of the general formula

PO₄³⁻, HPO₄²⁻, H₂PO₄⁻, R^{a}PO₄²⁻, HR^{a}PO₄⁻, R^{a}R^{b}PO₄⁻

the group of phosphonates and phosphinates of the general formula:

R^{a}HPO₃⁻, R^{a}R^{b}PO₂⁻, R^{a}R^{b}PO₃⁻

the group of phosphites of the general formula:

PO₃³⁻, HPO₃²⁻, H₂PO₃⁻, R^{a}PO₃²⁻, R^{a}HPO₃⁻, R^{a}R^{b}PO₃⁻

the group of phosphonites and phosphinites of the general formula:

R^{a}R^{b}PO₂⁻, R^{a}HPO₂⁻, R^{a}R^{b}PO⁻, R^{a}HPO⁻

the group of carboxylic acids of the general formula:

R^{a}COO⁻

the group of borates of the general formula:

BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO4)⁻

the group of boronates of the general formula:

R^{a}BO₂²⁻, R^{a}R^{b}BO⁻

the group of carbonates and carbonic acid esters of the general formula:

HCO₃⁻, CO₃²⁻, R^{a}CO₃⁻

the group of silicates and silicic acid esters of the general formula:

SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻

the group of alkyl- or arylsilane salts of the general formula:

R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻

the group of carboximides, bis(sulfonyl)imides, sulfonylimides and cyanamide of the general formula:

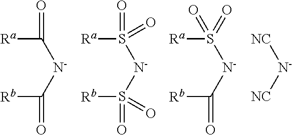

the group of methides of the general formula:

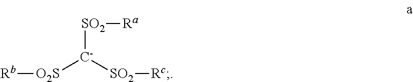

the group of alkoxides and aryl oxides of the general formulae:

R^{a}O⁻; A)

In these formulae, R^{a}, R^{b}, R^{c} and R^{d} mutually independently in each case mean hydrogen, C₁-C₃₀ alkyl, C₂-C₁₈ alkyl, C₆-C₁₄ aryl, C₅-C₁₂ cycloalkyl or a five- to six-membered heterocycle comprising oxygen and/or nitrogen atoms optionally interrupted by one or more non-adjacent oxygen atoms and/or one or more substituted or unsubstituted imino groups, wherein two thereof may together form an unsaturated, saturated or aromatic ring optionally interrupted by one or more oxygen atoms and/or one or more unsubstituted or substituted imino groups, wherein the stated residues may in each case additionally be substituted by functional groups, aryl, alkyl, aryloxy, alkyloxy, F, heteroatoms and/or heterocycles.

C₁-C₁₈ alkyl therein which are optionally substituted by functional groups, aryl, alkyl, aryloxy, alkyloxy, F, heteroatoms and/or heterocycles are for example methyl, ethyl, propyl, isopropyl, n-butyl, sec-butyl, tert.-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)-ethyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)-ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, trifluoromethyl, 1,1-dimethyl-2-chloroethyl, 2-methoxyisopropyl, 2-ethoxyethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, or 6-ethoxyhexyl.

C₂-C₁₈ alkyl which are optionally interrupted by one or more non-adjacent oxygen and/or one or more substituted or unsubstituted imino groups are for example 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two residues form a ring, these residues may together for example mean as the fused building block 1,3-propylene, 1,4-butylene, 2-oxa-1,3-propylene, 1-oxa-1,3-propylene, 2-oxa-1,3-propenylene, 1-aza-1,3-propenylene, 1-aza-1,3-propenylene, 1,4-buta-1,3-dienylene, 1-aza-1,4-buta-1,3-dienylene or 2-aza-1,4-buta-1,3-dienylene.

The number of non-adjacent oxygens and/or imino groups is in principle unlimited or is automatically limited by the size of the residue or of the ring building block. It generally amounts to no more than 5 in the respective residue, preferably no more than 4 or very particularly preferably no more than 3. Furthermore, there is/are generally at least one, preferably at least two carbon atom(s) located between two heteroatoms.

Substituted and unsubstituted imino groups may be, for example, imino, methylimino, iso-propylimino, n-butylimino or tert.-butylimino.

The term “functional groups” should for example be taken to mean the following: carboxy, carboxamide, hydroxy, di-(C₁-C₄-alkyl)-amino, alkyloxycarbonyl, cyano or C₁-C₄ alkoxy. C₁ to C₄ alkyl is here methyl, ethyl, propyl, isopropyl, n-butyl, sec-butyl or tert.-butyl.

C₆-C₁₄ aryl optionally substituted by functional groups, aryl, alkyl, aryloxy, alkyloxy, F, heteroatoms and/or heterocycles are for example phenyl, tolyl, xylyl, α-naphthyl, β-naphthyl, 4-diphenylyl, difluorophenyl, methylphenyl, dimethylphenyl, trimethylphenyl, ethylphenyl, diethylphenyl, iso-propylphenyl, tert.-butylphenyl, dodecylphenyl, methoxyphenyl, dimethoxyphenyl, ethoxyphenyl, hexyloxyphenyl, methylnaphthyl, isopropylnaphthyl, ethoxynaphthyl, 2,6-dimethylphenyl, 2,4,6-trimethylphenyl, 2,6-dimethoxyphenyl, 2- or 4-nitrophenol, 2,4- or 2,6-dinitrophenyl, 4-dimethylaminophenyl, 4-acetylphenyl, methoxyethylphenyl or ethoxymethylphenyl.

C₅-C₁₂ cycloalkyl optionally substituted by functional groups, aryl, alkyl, aryloxy, F, heteroatoms and/or heterocycles are for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, as well as a saturated or unsaturated bicyclic system such as norbornyl or norbornenyl.

A five- to six-membered heterocycle comprising oxygen and/or nitrogen atoms is for example furyl, pyryl, pyridyl, indolyl, benzoxazolyl, dioxolyl, dioxyl, benzimidazolyl, dimethylpyridyl, methylquinolyl, dimethylpyryl, methoxyfuryl, dimethoxypyridyl or difluoropyridyl.

Particularly preferred anions are selected from the group consisting of F⁻, BF₄⁻, PF₆⁻, CF₃SO₃⁻, (CF₃SO₃)₂N⁻, CF₃CO₂⁻, from the group of sulfates, sulfites and sulfonates of the general formula: SO₄²⁻, HSO₄⁻, SO₃²⁻, HSO₃⁻, R^{a}OSO₃⁻, R^{a}SO₃⁻, from the group of phosphates of the general formula PO₄³⁻, HPO₄²⁻, H₂PO₄⁻, R^{a}PO₄²⁻ from the group of borates of the formula BO₃³⁻, HBO₃²⁻, H₂BO₃₋, from the group of silicates and silicic acid esters of the formula SiO₄⁴⁻, HSiO₄³⁻, H₂SiO₄²⁻, H₃SiO₄⁻, of carboximides, bis(sulfonyl)imides, and sulfonylimides of the general formulae shown above, and mixtures thereof, wherein R^{a} and R^{b} are particularly preferably selected from methyl, ethyl, propyl or butyl.

In a further preferred embodiment, ionic liquids of the formula I are used with

[A]⁺: NH₄⁺, NH₃R⁺, NH₂R₃⁺, NHR₃⁺, NR₄⁺, 1-ethyl-2,3-dimethylimidazolium, P(OH)₄⁺, P(OR)₄⁺, PR₄⁺, wherein R is particularly preferably selected from methyl, ethyl, propyl or butyl.

In addition to the polyazole and the ionic liquid, the membrane according to the invention furthermore comprises at least one compound of the formula (P1)

R^{I}₄POH (P1)

wherein R^{I}, in each case mutually independently, is a residue which contains C, O and/or H optionally together with further atoms differing therefrom, wherein two residues R^{I} may optionally be joined to one another.

Preferred residues R^{I} comprise ═O (in this case two residues would be joined to one another), —OH, groups comprising 1-20 carbon atoms and alkoxy groups comprising 1-20 carbon atoms.

Particularly preferred compounds in this connection are those of the formula (P2),

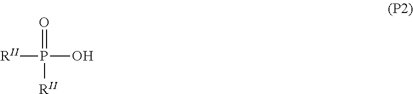

wherein R^{II} in each case mutually independently means a group comprising 1-20 carbon atoms, preferably an unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or a residue OR^{V},

in which R^{V} means H, a group comprising 1-20 carbon atoms, preferably an unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or a residue of the formula (P3)

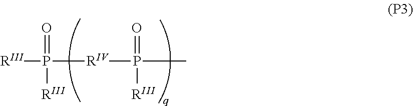

wherein

R^{III} in each case mutually independently means a group comprising 1-20 carbon atoms, preferably an unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or a residue OR^{VI},

wherein R^{IV} in each case mutually independently means O or a group comprising 1-20 carbon atoms, preferably an unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl,

R^{VI} in each case mutually independently means H or a group comprising 1-20 carbon atoms, preferably an unbranched and unsubstituted C₁-C₁₈ alkyl, such as for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl,

q means a number greater than or equal 1.

Compounds of the formula (P1) in particular comprise conventional commercial phosphoric acid, conventional commercial polyphosphoric acids Hₙ₊₂PₙO₃ₙ₊₁ (n>1), which are obtainable for example from Riedel-de Haen and preferably have a content, calculated (acidimetrically) as P₂O₅, of at least 83%, and known phosphonic acids, preferably C₁-C₁₈ alkylphosphonic acids.

The proportions of the polyazole, the ionic liquid and the compounds of the formula (P1) are not in principle subject to any particular restrictions and may be freely selected. Particularly favourable properties are, however, exhibited by polymer membranes which, in each case relative to the total weight thereof, contain
A) 0.5 wt. % to 40.0 wt. % polyazole,
B) 1.0 wt. % to 50.0 wt. % ionic liquid and
C) 10.0 wt. % to 98.5 wt. % compound of the formula (P1).

It is furthermore convenient for the polyazole and the ionic liquid to be present in a weight ratio in the range from 1:2 to 1:100.

Furthermore, where possible, the weight ratio of ionic liquid to compound of the formula (P1) should be selected in the range from 1:1 to 1:20, in particular in the range from 1:5 to 1:15.

For the purposes of a highly preferred variant, the polymer membrane according to the invention furthermore contains at least one polymer which is not a polyazole (polymer B)).

In this case, the weight ratio of polyazole to polymer (B) is preferably in the range from 0.1 to 50, preferably in the range from 0.2 to 20, particularly preferably in the range from 1 to 10.

Preferred polymers include inter alia polyolefins, such as poly(chloroprene), polyacetylene, polyphenylene; poly(p-xylylene), polyarylmethylene, polymethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyhexafluoropropylene, copolymers of PTFE with hexafluoropropylene, with perfluoropropyl vinyl ether, with trifluoronitrosomethane, with sulfonyl fluoride vinyl ether, with carbalkoxyperfluoroalkoxy vinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular prepared from norbornene;

polymers with C—O bonds in the main chain, for example

polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethylene terephthalate, polybutylene terephthalate, polyhydroxy benzoate, polyhydroxypropionic acid, polypivalolactone, polycaprolactone, polymalonic acid, polycarbonate;

Polymeric C—S bonds in the main chain, for example polysulfide ether, polyphenylene sulfide, polyether sulfone;

polymeric C—N bonds in the main chain, for example

polyimines, polyisocyanides, polyether imine, polyaniline, polyamides, polyhydrazides, polyurethanes, polyimides, polyazoles, polyazines;

liquid crystal polymers, in particular Vectra and

inorganic polymers, for example polysilanes, polycarbosilanes, polysiloxanes, polysilicic acid, polysilicates, silicones, polyphosphazenes and polythiazyl.

Moreover, polymers with covalently attached acid groups are also among preferred polymers (B). These acid groups in particular comprise sulfonic acid groups. The polymers modified with sulfonic acid groups preferably have a content of sulfonic acid groups in the range from 0.5 to 3 meq/g. This value is determined by means of the “ion exchange capacity” (IEC).

The IEC is measured by converting the sulfonic acid groups into the free acid. To this end, the polymer is treated in known manner with acid, any excess acid being removed by washing. The sulfonated polymer is accordingly initially treated for 2 hours in boiling water. Excess water is then blotted off and the sample dried for 15 hours at 160° C. in a vacuum drying cabinet at p<1 mbar. The dry weight of the membrane is then determined. The polymer dried in this manner is then dissolved in DMSO at 80° C. for 1 h. The solution is then titrated with 0.1 M NaOH. The ion exchange capacity (IEC) is then calculated from the quantity of acid consumed to reach the equivalence point and the dry weight.

Such polymers are known in specialist circles. Polymers containing sulfonic acid groups may accordingly be produced, for example, by sulfonating polymers. Methods for sulfonating polymers are described in F. Kucera et. al. Polymer Engineering and Science 1988, vol. 38, no. 5, 783-792. Sulfonation conditions may here be selected such that a low degree of sulfonation is obtained (DE-A-19959289).

A further class of non-fluorinated polymers has accordingly been developed by sulfonating high temperature resistant thermoplastics. Sulfonated polyether ketones (WO96/29360), sulfonated polysulfones (J. Membr. Sci. 83 (1993) p. 211) or sulfonated polyphenylene sulfide (DE-A-19527435) are accordingly known.

U.S. Pat. No. 6,110,616 describes copolymers of butadiene and styrene and the subsequent sulfonation thereof for fuel cell use.

Such polymers may moreover also be obtained by polyreactions of monomers comprising acid groups. Perfluorinated polymers as described in U.S. Pat. No. 5,422,411 may accordingly be produced by copolymerisation from trifluorostyrene and sulfonyl-modified trifluorostyrene.

One such perfluorosulfonic acid polymer is inter alia Nafion® (U.S. Pat. No. 3,692,569). This polymer may be dissolved as described in U.S. Pat. No. 4,453,991 and then used as an ionomer.

Preferred polymers with acid groups include inter alia sulfonated polyether ketones, sulfonated polysulfones, sulfonated polyphenylene sulfides, perfluorinated polymers containing sulfonic acid groups, as described in U.S. Pat. No. 3,692,569, U.S. Pat. No. 5,422,411 and U.S. Pat. No. 6,110,616.

Polymers (B) which are preferred for use in fuel cells with a continuous service temperature of above 100° C. are those which have a glass transition temperature or Vicat softening temperature VST/A/50 of at least 100° C., preferably of at least 150° C. and very particularly preferably of at least 180° C.

Polysulfones with a Vicat softening temperature VST/A/50 of 180° C. to 230° C. are here preferred.

Preferred polymers (B) are furthermore those which exhibit slight solubility and/or degradability in phosphoric acid. According to one particular embodiment of the present invention, treatment with 85% phosphoric acid brings about only insignificant weight loss. The weight ratio of the plate after phosphoric acid treatment to the weight of the plate before treatment is preferably greater than or equal to 0.8, in particular greater than or equal to 0.9 and particularly preferably greater than or equal to 0.95. This value is measured on a plate of polymer (B) which is 2 mm thick, 5 cm long and 2 cm wide. This plate is placed in phosphoric acid, the weight ratio of phosphoric acid to plate amounting to 10. The phosphoric acid is then heated to 100° C. with stirring for 24 hours. Any excess phosphoric acid is then removed from the plate by washing with water and the plate is dried. The plate is then reweighed.

Preferred polymers include polysulfones, in particular polysulfone with aromatic moieties in the main chain. According to one particular aspect of the present invention, preferred polysulfones and polyether sulfones exhibit a melt volume rate MVR 300/21.6, measured to ISO 1133, of less than or equal to 40 cm³/10 min, in particular of less than or equal to 30 cm³/10 min and particularly preferably of less than or equal to 20 cm³/10 min.

It has furthermore proved particularly effective for the purposes of the present invention for the polymer membrane to contain polymers comprising phosphonic acid groups which are obtainable by polymerising monomers comprising phosphonic acid groups. The polymers are here preferably obtainable by a method comprising the steps
A) imbibing at least one porous polyazole with a liquid which contains monomers comprising phosphonic acid groups, and
B) polymerising at least a proportion of the monomers comprising phosphonic acid groups which were introduced into the polymer film in step A).

Imbibition is taken to mean a weight gain of the porous polyazole of at least 3 wt. %. The weight gain preferably amounts to at least 5 wt. %, particularly preferably at least 10 wt. %.

The weight gain is determined gravimetrically from the mass of the porous support material before imbibition, m₀, and the mass of the polymer membrane after polymerisation according to step B), m₂.

Q=(m₂−m₀)/m₀×100

Imbibition preferably proceeds at a temperature of above 0° C., in particular of between room temperature (20° C.) and 180° C. in a liquid which preferably contains at least 5 wt. % of monomers comprising phosphonic acid groups. Imbibition may moreover also be carried out at elevated pressure and with ultrasound assistance. The limits are here set by considerations of economic viability and technical feasibility.

The polyazole used for imbibition generally has a thickness in the range from 5 to 1000 μm, preferably 10 to 500 μm, in particular 15 and 300 μm and particularly preferably between 30 and 250 μm. The production of such support materials is generally known, some of these being commercially obtainable.

Porous means that the polyazole has a large content of free volume which can be filled with a liquid. The free volume preferably amounts to at least 30% preferably at least 50%, at least 70% and very particularly preferably at least 90 vol. %, relative to the volume of the polyazole.

The pores of the polyazole may in general have a size in the range from 1 nm to 4000 nm, preferably 10 to 1000 nm.

The pores of the polyazole may in general have a volume in the range from 1 nm³ to 1 μm³, preferably 10 nm³ to 10000 nm³.

The pore volume of the polyazole may be obtained, for example, from the weight gain by imbibition with liquid. This parameter may moreover also be determined by the BET (Brunauer, Emmett & Teller) method.

Porous supports made from woven fabrics, nonwovens, foams or other porous materials may for example be used.

Polymer films with an open pore structure, woven polymer fabrics or polymer nonwovens are particularly preferably used. The open pore volume here amounts to more than 30%, preferably more than 50% and very particularly preferably more than 70%. The glass transition temperature of the organic base polymer of such a membrane is here higher than the operating temperature of the fuel cell and preferably amounts to at least 150° C., preferably at least 160° C. and very particularly preferably at least 180° C. Such membranes are used as separation membranes for ultrafiltration, gas separation, pervaporation, nanofiltration, microfiltration or haemodialysis.

The liquid which contains monomers comprising phosphonic acid groups may be a solution, it being possible for the liquid also to contain suspended and/or dispersed constituents. The viscosity of the liquid which contains monomers comprising phosphonic acid groups may vary over wide ranges, it being possible to adjust the viscosity by adding solvents or increasing temperature. Dynamic viscosity is preferably in the range from 0.1 to 10,000 mPa·s, in particular 0.2 to 2000 mPa·s, it being possible to measure these values, for example, according to DIN 53015.

Monomers comprising phosphonic acid groups are known in specialist circles. These are compounds which comprise at least one carbon-carbon double bond and at least one phosphonic acid group. The two carbon atoms which form the carbon-carbon double bond preferably comprise at least two, preferably 3, bonds to groups which result in low steric inhibition of the double bond. These groups include inter alia hydrogen atoms and halogen atoms, in particular fluorine atoms. For the purposes of the present invention, the polymer comprising phosphonic acid groups arises from the polymerisation product which is obtained by polymerisation of the monomer comprising phosphonic acid groups alone or with further monomers and/or crosslinking agents.

The monomer comprising phosphonic acid groups may comprise one, two, three or more carbon-carbon double bonds. The monomer comprising phosphonic acid groups may furthermore contain one, two, three or more phosphonic acid groups.

In general, the monomer comprising phosphonic acid groups contains 2 to 20, preferably 2 to 10 carbon atoms.

The monomer comprising phosphonic acid groups used in the production of the polymers comprising phosphonic acid groups are preferably compounds of the formula

in which

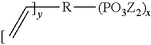

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group, ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10

y means an integer 1, 2, 3, 4, 5, 6, 7, 8, 9 or 10

and/or of the formula

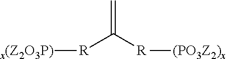

in which

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group, ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10

and/or of the formula

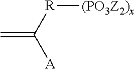

in which

A represents a group of the formulae COOR², CN, CONR²₂, OR² and/or R²,
A) in which R² means hydrogen, a C₁-C₁₅ alkyl group, C₁-C₁₅ alkoxy group, ethyleneoxy group or C₅-C₂₀ aryl or heteroaryl group, wherein the above residues may in turn be substituted with halogen, —OH, COOZ, —CN, NZ₂

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group; ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10.

Preferred monomers comprising phosphonic acid groups include inter alia alkenes which comprise phosphonic acid groups, such as ethenephosphonic acid, propenephosphonic acid, butenephosphonic acid; acrylic acid and/or methacrylic acid compounds which comprise phosphonic acid groups, such as for example 2-phosphonomethylacrylic acid, 2-phosphonomethylmethacrylic acid, 2-phosphonomethylacrylamide and 2-phosphonomethylmethacrylamide.

Conventional commercial vinylphosphonic acid (ethenephosphonic acid), as is obtainable for example from Aldrich, BASF SE or Archimica GmbH, is particularly preferably used. A preferred vinylphosphonic acid exhibits a purity of greater than 70%, in particular 90% and particularly preferably greater than 97% purity.

The monomers comprising phosphonic acid groups may moreover also be used in the form of derivatives, which may then be converted into the acid, wherein conversion into the acid may also proceed in the polymerised state. These derivatives include in particular the salts, esters, amides and halides of the monomers comprising phosphonic acid groups.

The liquid used in step A) preferably comprises at least 20 wt. %, in particular at least 30 wt. % and particularly preferably at least 50 wt. %, relative to the total weight of the mixture, of monomers comprising phosphonic acid groups.

The liquid used in step A) may additionally contain still further organic and/or inorganic solvents. Organic solvents in particular include polar aprotic solvents, such as dimethyl sulfoxide (DMSO), esters, such as ethyl acetate, and polar protic solvents, such as alcohols, such as ethanol, propanol, isopropanol and/or butanol. Inorganic solvents in particular include water, phosphoric acid and polyphosphoric acid.

These may have a positive impact on processability. The content of monomers comprising phosphonic acid groups in such liquids amounts in general to at least 5 wt. %, preferably at least 10 wt. %, particularly preferably between 10 and 97 wt. %.

According to one particular aspect of the present invention, the polymers comprising phosphonic acid groups may be produced using compositions which contain monomers comprising sulfonic acid groups.

Monomers comprising sulfonic acid groups are known in specialist circles. These are compounds which comprise at least one carbon-carbon double bond and at least one sulfonic acid group. The two carbon atoms which form the carbon-carbon double bond preferably comprise at least two, preferably 3, bonds to groups which result in low steric inhibition of the double bond. These groups include inter alia hydrogen atoms and halogen atoms, in particular fluorine atoms. For the purposes of the present invention, the polymer comprising sulfonic acid groups arises from the polymerisation product which is obtained by polymerisation of the monomer containing sulfonic acid groups alone or with further monomers and/or crosslinking agents.

The monomer comprising sulfonic acid groups may comprise one, two, three or more carbon-carbon double bonds. The monomer comprising sulfonic acid groups may furthermore contain one, two, three or more sulfonic acid groups.

In general, the monomer comprising sulfonic acid groups contains 2 to 20, preferably 2 to 10 carbon atoms.

The monomer comprising sulfonic acid groups preferably comprises compounds of the formula

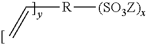

in which

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group, ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10

y means an integer 1, 2, 3, 4, 5, 6, 7, 8, 9 or 10

and/or of the formula

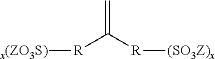

in which

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group, ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10

and/or of the formula

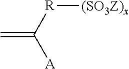

in which

A represents a group of the formulae COOR², CN, CONR²₂, OR² and/or R²,
A) in which R² means hydrogen, a C₁-C₁₅ alkyl group, C₁-C₁₅ alkoxy group, ethyleneoxy group or C₅-C₂₀ aryl or heteroaryl group, wherein the above residues may in turn be substituted with halogen, —OH, COOZ, —CN, NZ₂

R means a bond, a divalent C₁-C₁₅ alkylene group, divalent C₁-C₁₅ alkyleneoxy group, for example ethyleneoxy group or divalent C₅-C₂₀ aryl or heteroaryl group, wherein the above residues may in turn be substituted with halogen, —OH, COOZ, —CN, NZ₂,

Z mutually independently means hydrogen, C₁-C₁₅ alkyl group, C₁-C₁₅ alkoxy group, ethyleneoxy group or C₅-C₂₀ aryl or heteroaryl group, wherein the above residues may in turn be substituted with halogen, —OH, —CN, and

x means an integer 1, 2, 3, 4, 5, 6, 7, 8, 9 or 10.

Preferred monomers comprising sulfonic acid groups inter alia include alkenes which comprise sulfonic acid groups, such as ethenesulfonic acid, propenesulfonic acid, butenesulfonic acid; acrylic acid and/or methacrylic acid compounds which comprise sulfonic acid groups, such as for example 2-sulfonomethylacrylic acid, 2-sulfonomethylmethacrylic acid, 2-sulfonomethylacrylamide and 2-sulfonomethylmethacrylamide.

Conventional commercial vinylsulfonic acid (ethenesulfonic acid), as is obtainable for example from Aldrich or Clariant GmbH, is particularly preferably used. A preferred vinylsulfonic acid exhibits a purity of greater than 70%, in particular 90% and particularly preferably greater than 97% purity.

The monomers comprising sulfonic acid groups may moreover also be used in the form of derivatives, which may then be converted into the acid, wherein conversion into the acid may also proceed in the polymerised state. These derivatives include in particular the salts, esters, amides and halides of the monomers comprising sulfonic acid groups.

According to one particular aspect of the present invention, the weight ratio of monomers comprising sulfonic acid groups to monomers comprising phosphonic acid groups may be in the range from 100:1 to 1:100, preferably 10:1 to 1:10 and particularly preferably 2:1 to 1:2.

In a further embodiment of the invention, monomers capable of crosslinking may be used in the production of the polymer membrane. These monomers may be added to the liquid according to step A).

The monomers capable of crosslinking are in particular compounds which comprise at least 2 carbon-carbon double bonds. Dienes, trienes, tetraenes, dimethyl acrylates, trimethyl acrylates, tetramethyl acrylates, diacrylates, triacrylates, tetraacrylates are preferred.

Particularly preferred are dienes, trienes, tetraenes are of the formula

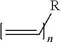

dimethyl acrylates, trimethyl acrylates, tetramethyl acrylates of the formula

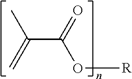

diacrylates, triacrylates, tetraacrylates of the formula

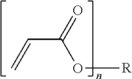

in which

R means a C₁-C₁₅ alkyl group, C₅-C₂₀ aryl or heteroaryl group, NR′, —SO₂, PR′, Si(R′)₂, wherein the above residues may in turn be substituted,

R′ mutually independently means hydrogen, a C₁-C₁₅ alkyl group, C₁-C₁₅ alkoxy group, C₅-C₂₀ aryl or heteroaryl group and

n is at least 2.

The substituents of the above residue R preferably comprise halogen, hydroxyl, carboxy, carboxyl, carboxyl ester, nitrile, amine, silyl, siloxane residues.

Particularly preferred crosslinking agents are allyl methacrylate, ethylene glycol dimethacrylate, diethylene glycol dimethacrylate, triethylene glycol dimethacrylate, tetra- and polyethylene glycol dimethacrylate, 1,3-butanediol dimethacrylate, glycerol dimethacrylate, diurethane dimethacrylate, trimethylpropane trimethacrylate, epoxy acrylates, for example Ebacryl, N′,N-methylenebisacrylamide, carbinol, butadiene, isoprene, chloroprene, divinylbenzene and/or bisphenol-A dimethyl acrylate. These compounds are commercially obtainable for example from Sartomer Company Exton, Pa. under the names CN-120, CN104 and CN-980.

The use of crosslinking agents is optional, wherein these compounds may conventionally be used in the range between 0.05 to 30 wt. %, preferably 0.1 to 20 wt. %, particularly preferably 1 and 10 wt. %, relative to the weight of the monomers comprising phosphonic acid groups.

Applicational properties may be further improved by also adding fillers, in particular proton-conducting fillers, and additional acids to the polymer membrane.

Non-limiting examples of proton-conducting fillers are

sulfates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,

phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,

polyacids such as H₃PW₁₂O₄₀.nH₂O (n=21-29), H₃SiW₁₂O₄₀.nH₂O (n=21-29), HₓWO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄

selenites and arsenides such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,

oxides such as Al₂O₃, Sb₂O₅, ThO₂, SnO₂, ZrO₂, MoO₃

silicates such as zeolites, zeolites(NH₄+), phyllosilicates, tectosilicates, H-natrolites, H-mordenites, NH₄-analcines, NH₄-sodalites, NH₄-gallates, H-montmorillonites

acids such as HClO₄, SbF₅

fillers such as carbides, in particular SiC, Si₃N₄, fibres, in particular glass fibres, glass powders and/or polymer fibres, preferably based on polyazoles.

These additives may be present in the polymer membrane in conventional quantities, but the positive properties of the membrane, such as elevated conductivity, long life span and elevated mechanical stability should not be impaired too much by adding excessively large quantities of additives. In general, the membrane comprises at most 80 wt. %, preferably at most 50 wt. % and particularly preferably at most 20 wt. % of additives.

The polymer membrane may furthermore also contain perfluorinated sulfonic acid additives (preferably 0.1-20 wt. %, preferentially 0.2-15 wt. %, highly preferably 0.2-10 wt. %). These additives enhance performance, in the vicinity of the cathode increasing oxygen solubility and oxygen diffusion and reducing adsorption of phosphoric acid and phosphate onto platinum. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.)

Non-limiting examples of persulfonated additives are:

trifluoromethanesulfonic acid, potassium trifluoromethanesulfonate, sodium trifluoromethanesulfonate, lithium trifluoromethanesulfonate, ammonium trifluoromethanesulfonate, potassium perfluorohexanesulfonate, sodium perfluorohexanesulfonate, lithium perfluorohexanesulfonate, ammonium perfluorohexanesulfonate, perfluorohexanesulfonic acid, potassium nonafluorobutanesulfonate, sodium nonafluorobutanesulfonate, lithium nonafluorobutanesulfonate, ammonium nonafluorobutanesulfonate, caesium nonafluorobutanesulfonate, triethylammonium perfluorohexanesulfonate, perfluorosulfoimides and Nafion.

The membrane according to the invention may be produced in a manner known per se, for example by preparing, knife coating and solidifying a solution of the components polyazole, ionic liquid and compound of the formula (P1).

According to one particularly preferred variant of the present invention, however, the polyazole is already produced in the presence of at least one compound of the formula (P1) or at least one compound which, on hydrolysis, yields at least one compound of the formula (P1), particularly preferably in the presence of polyphosphoric acid. To this end, one or more compounds which, on exposure to heat, are capable of forming polyazoles may be added to the compound of the formula (P1) or to the compound which, on hydrolysis, yields at least one compound of the formula (P1).

Suitable compounds which, on hydrolysis, yield at least one compound of the formula (P1), comprise polyphosphoric acid and organic phosphonic anhydrides, in particular cyclic compounds of the formula

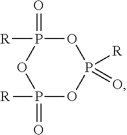

linear compounds of the formula

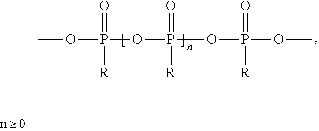

and

anhydrides of polyorganic phosphonic acids, such as for example of the formula of anhydrides of diphosphonic acid

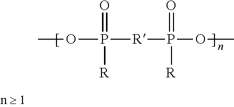

in which the residues R and R′ are identical or different and denote a group containing C₁-C₂₀ carbon atoms.

For the purposes of the present invention, a group containing C₁-C₂₀ carbon atoms is preferably taken to mean the residues C₁-C₂₀ alkyl, particularly preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₂₀ alkenyl, particularly preferably ethenyl, propenyl, butenyl, pentenyl, cyclopentenyl, hexenyl, cyclohexenyl, octenyl or cyclooctenyl, C₁-C₂₀ alkynyl, particularly preferably ethynyl, propynyl, butynyl, pentynyl, hexynyl or octynyl, C₆-C₂₀) aryl, particularly preferably phenyl, biphenyl, naphthyl or anthracenyl, C₁-C₂₀ fluoroalkyl, particularly preferably trifluoromethyl, pentafluoroethyl or 2,2,2-trifluoroethyl, C₆-C₂₀) aryl, particularly preferably phenyl, biphenyl, naphthyl, anthracenyl, triphenylenyl, [1,1′;3′,1″]terphenyl-2′-yl, binaphthyl or phenanthrenyl, C₆-C₂₀ fluoroaryl, particularly preferably tetrafluorophenyl or heptafluoronaphthyl, C₁-C₂₀ alkoxy, particularly preferably methoxy, ethoxy, n-propoxy, i-propoxy, n-butoxy, i-butoxy, s-butoxy or t-butoxy, C₆-C₂₀ aryloxy, particularly preferably phenoxy, naphthoxy, biphenyloxy, anthracenyloxy, phenanthrenyloxy, C₇-C₂₀ arylalkyl, particularly preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀ alkylaryl, particularly preferably benzyl, ethylphenyl, propylphenyl, diphenylmethyl, triphenylmethyl or naphthalenylmethyl, C₇-C₂₀ aryloxyalkyl, particularly preferably o-methoxyphenyl, m-phenoxymethyl, p-phenoxymethyl, C₁₂-C₂₀ aryloxyaryl, particularly preferably p-phenoxyphenyl, C₅-C₂₀ heteroaryl, particularly preferably 2-pyridyl, 3-pyridyl, 4-pyridyl, quinolinyl, isoquinolinyl, acridinyl, benzoquinolinyl or benzoisoquinolinyl, C₄-C₂₀ heterocycloalkyl, particularly preferably furyl, benzofuryl, 2-pyrrolidinyl, 2-indolyl, 3-indolyl, 2,3-dihydroindolyl, C₈-C₂₀ arylalkenyl, particularly preferably o-vinylphenyl, m-vinylphenyl, p-vinylphenyl, C₈-C₂₀ arylalkynyl, particularly preferably o-ethynylphenyl, m-ethynylphenyl or p-ethynylphenyl, C₂-C₂₀ heteroatom-containing group, particularly preferably carbonyl, benzoyl, oxybenzoyl, benzoyloxy, acetyl, acetoxy or nitrile, wherein one or more groups containing C₁-C₂₀ carbon atoms may form a cyclic system.

In the above-stated groups containing C₁-C₂₀ carbon atoms, one or more non-adjacent CH₂ groups may be replaced by —O—, —S—, —NR¹— or —CONR²— and one or more H atoms may be replaced by F.

In the above-stated groups containing C₁-C₂₀ carbon atoms which comprise aromatic systems, one or more non-adjacent CH groups may be replaced by —O—, —S—, —NR¹— or —CONR²— and one or more H atoms may be replaced by F.

The residues R¹ and R² are identical or different on each occurrence of H or an aliphatic or aromatic hydrocarbon residue with 1 to 20 C atoms.

Particularly preferred organic phosphonic anhydrides are those which are partially fluorinated or perfluorinated.

The stated organic phosphonic anhydrides are commercially obtainable, for example the product ®T3P (propane phosphonic anhydride) from Archimica.

The organic phosphonic anhydrides may also be used in combination with polyphosphoric acid and/or with P₂O₅. The polyphosphoric acid comprises conventional commercial polyphosphoric acids as are for example obtainable from Riedel-de Haen. Polyphosphoric acids Hₙ₊₂PₙO₃ₙ₊₁ (n>1) conventionally have a content, calculated (acidimetrically) as P₂O₅, of at least 83%. Instead of a solution of the monomers, a dispersion/suspension may also be produced.

The organic phosphonic anhydrides may also be used in combination with mono- and/or polyorganic phosphonic acids.

The mono- and/or polyorganic phosphonic acids comprise compounds of the formula

R—PO₃H₂

H₂O₃P—R—PO₃H₂

RPO₃H₂]ₙ
A) n≧2

in which the residue R is identical or different and denotes a group containing C₁-C₂₀ carbon atoms.

For the purposes of the present invention, a group containing C₁-C₂₀ carbon atoms is preferably taken to mean the residues C₁-C₂₀ alkyl, particularly preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₆-C₂₀) aryl, particularly preferably phenyl, biphenyl, naphthyl or anthracenyl, C₁-C₂₀ fluoroalkyl, particularly preferably trifluoromethyl, pentafluoroethyl or 2,2,2-trifluoroethyl, C₆-C₂₀) aryl, particularly preferably phenyl, biphenyl, naphthyl, anthracenyl, triphenylenyl, [1,1′;3′,1″]terphenyl-2′-yl, binaphthyl or phenanthrenyl, C₆-C₂₀ fluoroaryl, particularly preferably tetrafluorophenyl or heptafluoronaphthyl, C₁-C₂₀ alkoxy, particularly preferably methoxy, ethoxy, n-propoxy, i-propoxy, n-butoxy, i-butoxy, s-butoxy or t-butoxy, C₆-C₂₀ aryloxy, particularly preferably phenoxy, naphthoxy, biphenyloxy, anthracenyloxy, phenanthrenyloxy, C₇-C₂₀ arylalkyl, particularly preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀ alkylaryl, particularly preferably benzyl, ethylphenyl, propylphenyl, diphenylmethyl, triphenylmethyl or naphthalenylmethyl, C₇-C₂₀ aryloxyalkyl, particularly preferably o-methoxyphenyl, m-phenoxymethyl, p-phenoxymethyl, C₁₂-C₂₀ aryloxyaryl, particularly preferably p-phenoxyphenyl, C₅-C₂₀ heteroaryl, particularly preferably 2-pyridyl, 3-pyridyl, 4-pyridyl, quinolinyl, isoquinolinyl, acridinyl, benzoquinolinyl or benzoisoquinolinyl, C₄-C₂₀ heterocycloalkyl, particularly preferably furyl, benzofuryl, 2-pyrrolidinyl, 2-indolyl, 3-indolyl, 2,3-dihydroindolyl, C₂-C₂₀ heteroatom-containing group, particularly preferably carbonyl, benzoyl, oxybenzoyl, benzoyloxy, acetyl, acetoxy or nitrile, wherein one or more groups containing C₁-C₂₀ carbon atoms may form a cyclic system.

In the above-stated groups containing C₁-C₂₀ carbon atoms, one or more non-adjacent CH₂ groups may be replaced by —O—, —S—, —NR¹— or —CONR²— and one or more H atoms may be replaced by F.

In the above-stated groups containing C₁-C₂₀ carbon atoms which comprise aromatic systems, one or more non-adjacent CH groups may be replaced by —O—, —S—, —NR¹— or —CONR²— and one or more H atoms may be replaced by F.

The residues R¹ and R² are identical or different on each occurrence of H or an aliphatic or aromatic hydrocarbon residue with 1 to 20 C atoms.

Particularly preferred organic phosphonic acids are those which are partially fluorinated or perfluorinated.

Organic phosphonic acids are commercially obtainable, for example the products from Clariant or Aldrich.

Phosphonic acids containing vinyl, as are described in German Patent application no. 10213540.1, are preferably not used.

The compound of the formula (P1) or the compound which, on hydrolysis, yields at least one compound of the formula (P1) is preferably used in a weight ratio of the sum of all compounds of the formula (P1) and all compounds which, on hydrolysis, yield at least one compound of the formula (P1), to the sum of all monomers of 1:10000 to 10000:1, preferably of 1:1000 to 1000:1, in particular of 1:100 to 100:1.

Mixtures which are particularly suitable for producing the polyazole in the presence of at least one compound of the formula (P1) or at least one compound which, on hydrolysis, yields at least a compound of the formula (P1) comprise one or more aromatic and/or heteroaromatic tetra-amino compounds and one or more aromatic and/or heteroaromatic carboxylic acids or the derivatives thereof, which [contain] at least two acid groups per carboxylic acid monomer. One or more aromatic and/or heteroaromatic diaminocarboxylic acids may moreover be used for producing polyazoles.

The aromatic and heteroaromatic tetra-amino compounds include, inter alia 3,3′,4,4′-tetraminobiphenyl, 2,3,5,6-tetraminopyridine, 1,2,4,5-tetraminobenzene, 3,3′,4,4′-tetraminodiphenyl sulfone, 3,3′,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane

and the salts thereof, in particular the mono-, di-, tri- and tetrahydrochloride derivatives thereof. Of these, 3,3′,4,4′-tetraminobiphenyl, 2,3,5,6-tetraminopyridine and 1,2,4,5-tetraminobenzene are particularly preferred.

The mixture may moreover comprise aromatic and/or heteroaromatic carboxylic acids. These comprise dicarboxylic acids and tricarboxylic acids and tetracarboxylic acids or the esters thereof or the anhydrides thereof or the acid halides thereof, in particular the acid halides and/or acid bromides thereof. The aromatic dicarboxylic acids preferably comprise isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid. 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenyl sulfone-4,4′-dicarboxylic acid, biphenyl-4,4′-dicarboxylic acid, 4-trifluoromethylphthalic acid, 2,2-bis(4-carboxyphenyl)hexafluoropropane, 4,4′-stilbenedicarboxylic acid, 4-carboxycinnamic acid, or the C₁-C₂₀ alkyl esters or C₅-C₁₂ aryl esters thereof, or the acid anhydrides thereof or the acid chlorides thereof.

The aromatic tricarboxylic acids or the C₁-C₂₀ alkyl esters or C₅-C₁₂ aryl esters thereof or the acid anhydrides thereof or the acid chlorides thereof preferably comprise 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid, 3,5,4′-biphenyltricarboxylic acid.

The aromatic tetracarboxylic acids or the C₁-C₂₀ alkyl esters or C₅-C₁₂ aryl esters thereof or the acid anhydrides thereof or the acid chlorides thereof preferably comprise 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid, 1,4,5,8-naphthalenetetracarboxylic acid.

The heteroaromatic carboxylic acids preferably comprise heteroaromatic dicarboxylic acids and tricarboxylic acids and tetracarboxylic acids or the esters thereof or the anhydrides thereof. Heteroaromatic carboxylic acids are taken to be aromatic systems which contain at least one nitrogen, oxygen, sulfur or phosphorus atom in the aromatic moiety. They preferably comprise pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid, benzimidazole-5,6-dicarboxylic acid and the C₁-C₂₀ alkyl esters or C₅-C₁₂ aryl esters thereof, or the acid anhydrides thereof or the acid chlorides thereof.

The content of tricarboxylic acid or tetracarboxylic acids (relative to the introduced dicarboxylic acid) amounts to between 0 and 30 mol %, preferably 0.1 and 20 mol %, in particular 0.5 and 10 mol %.

Aromatic and heteroaromatic diaminocarboxylic acids may furthermore also be used. These include inter alia diaminobenzoic acid, 4-phenoxycarbonyl-3,′4′-diaminodiphenyl ether and the mono- and dihydrochloride derivatives thereof.

Preferably, mixtures of at least 2 different aromatic carboxylic acids are used. Mixtures which are particularly preferably used are those which, in addition to aromatic carboxylic acids, also contain heteroaromatic carboxylic acids. The mixing ratio of aromatic carboxylic acids to heteroaromatic carboxylic acids amounts to between 1:99 and 99:1, preferably between 1:50 to 50:1.

These mixtures in particular comprise mixtures of N-heteroaromatic dicarboxylic acids and aromatic dicarboxylic acids. Non-limiting examples of dicarboxylic acids are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenyl sulfone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

If a molecular weight which is as high as possible is to be achieved, the molar ratio of carboxylic acid groups to amino groups during the reaction of tetra-amino compounds with one or more aromatic carboxylic acids or the esters thereof, which contain at least two acid groups per carboxylic acid monomer, is preferably in the vicinity of 1:2.

Preferably at least 0.5 wt. %, in particular 1 to 30 wt. % and particularly preferably 2 to 1.5 wt. % of monomers are used to produce polyazoles, in each case relative to the resultant weight of the composition to be used.

If the polyazoles are produced from the monomers directly in the compound of the formula (P1) or the compound which, on hydrolysis, yields at least one compound of the formula (P1), the polyazoles are distinguished by an elevated molecular weight. This is particularly the case for polybenzimidazoles. Measured as intrinsic viscosity, this is in the range from 0.3 to 10 dl/g, preferably in the range from 1 to 5 dl/g.

Where tricarboxylic acids or tetracarboxylic acid are also used, they give rise to branching/crosslinking of the resultant polymers. This contributes an improvement in mechanical properties.

According to a further aspect of the present invention, compounds are used which, on exposure to heat, are suitable for forming polyazoles, wherein these compounds are obtainable by reacting one or more aromatic and/or heteroaromatic tetra-amino compounds with one or more aromatic and/or heteroaromatic carboxylic acids or the derivatives thereof, which contain at least two acid groups per carboxylic acid monomer, or one or more aromatic and/or heteroaromatic diaminocarboxylic acids in a melt at temperatures of up to 400° C., in particular of up to 350° C., preferably of up to 280° C. The compounds to be used for producing these prepolymers have been described above.

A very particularly preferred method for producing the polymer membrane according to the invention is one which comprises the following steps:
A) mixing one or more aromatic tetra-amino compounds with one or more aromatic carboxylic acids or the esters thereof, which contain at least two acid groups per carboxylic acid monomer, or mixing one or more aromatic and/or heteroaromatic diaminocarboxylic acids, in at least one compound of the formula (P1) or at least one compound which, on hydrolysis, yields at least one compound of the formula (P1), to form a solution and/or dispersion
B) applying a layer using the mixture according to step A) onto a support or onto a electrode,
C) heating the planar structure/layer obtainable according to step B) under inert gas to temperatures of up to 350° C., preferably of up to 280° C., to form the polyazole polymer,
D) treating the membrane formed in step C) (until it is self-supporting).

The use of polyphosphoric acid is also very particularly convenient for the purposes of this embodiment of the method.

The mixture produced in step A) preferably has a weight ratio of the sum of all compounds of the formula (P1) and all compounds which, on hydrolysis, yield at least one compound of the formula (P1) to the sum of all monomers of 1:10000 to 10000:1, preferably of 1:1000 to 1000:1, in particular of 1:100 to 100:1.

Layer formation according to step B) proceeds by means of per se known measures, in particular casting, spraying and/or knife coating, which are known for polymer film production from the prior art. Suitable supports are any supports which may be described as inert under the conditions. Viscosity may be adjusted by optionally combining the solution with phosphoric acid (conc. phosphoric acid, 85%). In this manner, viscosity may be adjusted to the desired value and membrane formation facilitated.

The layer produced according to step B) preferably has a thickness of between 20 and 4000 μm, preferably of between 30 and 3500 μm, in particular of between 50 and 3000 μm.

In order to form the polyazole polymer, the planar structure or the layer obtainable according to step B) is heated under inert gas to temperatures of up to 350° C., preferably of up to 280° C.

Alternatively, the formation of oligomers and/or polymers may also be brought about by heating the mixture from step A) to temperatures of up to 350° C., preferably of up to 280° C. Depending on the selected temperature and duration, it is then possible partly or entirely to dispense with the heating in step C).

It has furthermore been found that when using aromatic dicarboxylic acids (or heteroaromatic dicarboxylic acid) such as isophthalic acid, terephthalic acid, 2,5-dihydroxyterephthalic acid, 4,6-dihydroxyisophthalic acid, 2,6-dihydroxyisophthalic acid, diphenic acid, 1,8-dihydroxynaphthalene-3,6-dicarboxylic acid, diphenyl ether-4,4′-dicarboxylic acid, benzophenone-4,4′-dicarboxylic acid, diphenyl sulfone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, a temperature in step C), or in step A) if it is desired to form oligomers and/or polymers already in that step, in the range of up to 300° C., preferably of between 100° C. and 250° C., is favourable.

If polyphosphoric acid is used in the method, treatment of the membrane in step D) preferably proceeds at temperatures of above 0° C. and less than 150° C., preferably at temperatures of between 10° C. and 120° C., in particular between room temperature (20° C.) and 90° C., in the presence of moisture or water and/or steam and/or hydrous phosphoric acid of up to 85% strength. Treatment preferably proceeds under normal pressure, but may also proceed with exposure to pressure. It is essential for treatment to proceed in the presence of sufficient moisture, whereby, by undergoing partial hydrolysis to form low molecular weight polyphosphoric acid and/or phosphoric acid, the polyphosphoric acid present contributes to solidification of the membrane.

Partial hydrolysis of the polyphosphoric acid in step D) leads to solidification of the membrane and to a reduction in film thickness and formation of a membrane with a thickness of preferably between 15 and 3000 μm, preferably between 20 and 2000 μm, in particular between 20 and 1500 μm, which is self-supporting. The intra- and intermolecular structures (interpenetrating networks (IPN)) present in the polyphosphoric acid layer according to step B) lead to ordered membrane formation in step C) which is responsible for the particular properties of the membrane formed.

The upper temperature limit for treatment according to step D) generally amounts to 150° C. In the case of extremely brief exposure to moisture, for example to superheated steam, said steam may also be hotter than 150° C. The upper temperature limit is substantially determined by the duration of the treatment.

Partial hydrolysis (step D) may also proceed in conditioning cabinets, in which hydrolysis may be purposefully controlled with defined exposure to moisture. The moisture content may here be adjusted by the temperature or saturation of the contacting environment, for example gases such as air, nitrogen, carbon dioxide or other suitable gases, or steam. Treatment time is dependent on the above-selected parameters.

Treatment time is furthermore dependent on the thickness of the membrane.

The treatment time generally amounts to between a few seconds to minutes, for example in the case of exposure to superheated steam, or up to whole days, for example in air at room temperature and low relative atmospheric humidity. The treatment time preferably amounts to between 10 seconds and 300 hours, in particular 1 minute to 200 hours.

If partial hydrolysis is performed at room temperature (20° C.) with ambient air of a relative atmospheric humidity of 40-80%, the treatment time amounts to between 1 and 200 hours.

The membrane obtained according to step D) may be made self-supporting, i.e. it can be detached from the support without suffering damage and then optionally be directly further processed.

The concentration of phosphoric acid and thus the conductivity of the polymer membranes according to the invention may be adjusted by the degree of hydrolysis, i.e. duration, temperature and ambient humidity. According to the invention, the concentration of phosphoric acid is stated as mol of acid per mol of polymer repeat unit. For the purposes of the present invention, a concentration (mol of phosphoric acid relative to one repeat unit of the formula (III), i.e. polybenzimidazole) of between 10 and 50, in particular between 12 and 40, is preferred. Such high doping rates (concentrations) can be achieved only with great difficulty, if at all, by doping polyazoles with commercially obtainable orthophosphoric acid.

Subsequent to the treatment according to step D), the membrane may also be crosslinked on the surface by exposure to heat in the presence of atmospheric oxygen. This curing of the membrane additionally improves the properties of the membrane.

Crosslinking may also proceed by exposure to IR or NIR (IR=infrared, i.e. light with a wavelength of greater than 700 nm; NIR=near IR, i.e. light with a wavelength in the range from approx. 700 to 2000 nm or with an energy in the range from approx. 0.6 to 1.75 eV). A further method is irradiation with β radiation. The radiation dose here amounts to between 5 and 200 kGy.

For the purposes of the present invention, the ionic liquid is preferably introduced into the membrane by

already adding the ionic liquid to the solution or dispersion of step A) and carrying out the following steps B), C) and D) in the presence of the ionic liquid or

subsequently introducing the ionic liquid into the formed membrane.

The first variant here requires that, under the reaction conditions of the following steps B), C) and D) and any further steps, the ionic liquid is inert or at least does not have a disadvantageous effect on the properties of the resultant membrane. It has the advantage that the composition of the resultant membrane may be adjusted comparatively straightforwardly and directly.

The second variant has the advantage over the first that it is also possible to use those ionic liquids which are not inert and/or might be washed out under the reaction conditions of the following steps B), C) and D) and any further steps.

The second variant may in particular be realised by initially producing the membrane, then entirely or partially washing out the compound of the formula (P1) or the compound which, on hydrolysis, yields at least one compound of the formula (P1), in particular polyphosphoric acid and/or phosphoric acid, and then reimpregnating the membrane with at least one compound of the formula (P1), preferably phosphoric acid and/or polyphosphoric acid, and the ionic liquid, for example by immersing the membrane in a bath which contains the desired impregnating composition. The approach of completely washing out the compound of the formula (P1) or the compound which, on hydrolysis, yields at least one compound of the formula (P1) offers the advantage that the ratio of compound of the formula (P1) to ionic liquid may be purposefully adjusted in the resultant membrane.

Alternatively, it has also proved particularly effective to use at least one compound which, on hydrolysis, yields at least one compound of the formula (P1), and to carry out hydrolysis of the compound (step D)) using a composition which contains the desired ionic liquid. It is advantageous here that the membrane's particularly high doping rates are retained. Compositions for hydrolysis which are particularly suitable for these purposes contain at least one compound of the formula (P1) and the desired ionic liquid, in particular phosphoric acid and the desired ionic liquid.

The polymer membrane according to the invention exhibits improved material properties relative to hitherto known doped polymer membranes. In particular, they exhibit better conductivity in comparison with known doped polymer membranes. This is in particular due to improved proton conductivity which, at temperatures of 120° C., amounts to at least 0.1 S/cm, preferably at least 0.11 S/cm, in particular at least 0.12 S/cm.

The polymer membrane according to the invention is further distinguished by improved mechanical properties, in particular by an improved modulus of elasticity, improved fracture toughness and improved elongation at break. For instance, relative to a membrane which is of identical composition but comprises no ionic liquid, the polymer membrane according to the invention preferably exhibits at least 20% higher fracture toughness. Furthermore, the elongation at break of the polymer membrane according to the invention is preferably at least 200%, in particular at least 250%, and stress preferably at least 2.6 MPa, in particular at least 2.8 MPa.

Possible fields of application of the doped polymer membranes according to the invention include inter alia use in fuel cells, in electrolysis, in capacitors and in battery systems. On the basis of their profile of properties, the doped polymer membranes are preferably used in fuel cells.

The present invention also relates to a membrane-electrode unit which comprises at least one polymer membrane according to the invention. Reference is made to the specialist literature, in particular to U.S. Pat. No. 4,191,618, U.S. Pat. No. 4,212,714 and U.S. Pat. No. 4,333,805, for further information about membrane-electrode units. The disclosure made in the above-stated literature references [U.S. Pat. No. 4,191,618, U.S. Pat. No. 4,212,714 and U.S. Pat. No. 4,333,805] with regard to the structure and production of membrane-electrode units, and to the electrodes, gas diffusion layers and catalysts to be selected is also part of the present description.

In one variant of the present invention, instead of being formed on a support, the membrane may also be formed directly on the electrode. In this way, the treatment according to step D) may be correspondingly shortened, as the membrane no longer needs to be self-supporting. Such a membrane is also provided by the present invention.

The present invention also provides an electrode with a proton-conducting polymer coating comprising at least one polyazole, at least one ionic liquid and at least one compound of the formula (P1).

Such a coated electrode may be incorporated into a membrane-electrode unit which optionally comprises at least one polymer membrane according to the invention.

The invention is further illustrated below by an example and a comparative example, without this being intended to limit the concept of the invention.

### EXAMPLES

### Comparative Example

### Poly(2,2′-(m-phenylene)-5,5′-bibenzimidazole (PBI) membrane

Example 1 of WO 02/088219 was repeated.

525.95 g of polyphosphoric acid (PPA) was added to a mixture of 32.338 g of isophthalic acid (0.195 mol) and 41.687 g 3.3′,4,4′-tetraminobiphenyl (0.195 mol) in a three-necked flask which was fitted with a mechanical stirrer, N₂ inlet and outlet. The mixture was heated with stirring, initially to 120° C. for 2 h, then to 150° C. for 3 h, then to 180° C. for 2 h, and then to 220° C. for 16 h. 200 g of 85% phosphoric acid was then added to this solution at 220° C. The resultant solution was stirred for 2 h at 220° C. and finally raised to 240° C. for 1 h. The highly viscous solution was knife coated onto a glass sheet at this temperature using a preheated knife coater. A transparent, dark brown coloured poly(2,2′-(m-phenylene)-5,5′-bibenzimidazole (PBI) membrane was obtained. The membrane was then left to stand for 1 h at RT in order to obtain a self-supporting membrane.

A small proportion of the solution was precipitated with water. The precipitated resin was filtered, washed three times with H₂O, neutralised with ammonium hydroxide, then washed with H₂O and dried at 100° C. and 0.001 bar for 24 h. The inherent viscosity ηᵢₙₕ was measured on a 0.2 g/dl PBI solution in 100 ml of 96% H₂SO₄. ηᵢₙₕ=1.8 dl/g at 30° C.

### Example

The polybenzimidazole/H₃PO₄ membrane of the comparative examples was washed with water. The wet membrane was then twice laid at room temperature in an IL (EMIMEtOSO₃ (1-ethyl-3-methylimidazolium ethyl sulfate)):H₃PO₄ bath (weight ratio 1:9). The membrane was then taken out of the bath and blotted off.

The conductivity and tensile stress properties of the resultant membranes were determined as follows:

Measurement Method for Specific Conductivity

Specific conductivity is measured by means of impedance spectroscopy in a 4-pole arrangement in potentiostatic mode and using platinum electrodes (wire, 0.25 mm diameter). The distance between the current-collecting electrodes amounts to 2 cm. The spectrum obtained is evaluated using a simple model consisting of a parallel arrangement of an ohmic resistor and a capacitor. The sample cross-section of the phosphoric acid-doped membrane is measured immediately before mounting the sample. Temperature dependency is measured by adjusting the measurement cell to the desired temperature in a furnace and controlled by a Pt-100 thermocouple positioned in the immediate vicinity of the sample. Once the temperature has been reached, the sample is kept at this temperature for 10 minutes before starting the measurement.

Measurement of elongation at break/stress is carried out on a sample strip with a width of 15 mm and a length of 120 mm. Tensile testing proceeds at a temperature of 30° C. with an elongation rate of 50 mm/min. Fracture toughness is obtained as the area below the elongation at break/stress curve.

Table 1 summarises the results obtained.

TABLE 1

| | Comparative Example | Example |
|---|---|---|
| Modulus of elasticity [MPa] | 1.7-2.5 | 2.8-3.1 |
| Fracture toughness [kJ/m²] | 70-112 | >140 |
| Elongation at break [%] | 140 | >275 |
| Conductivity @160° C. [S/cm] | 160 | 153 |

1-19. (canceled)

20. A proton-conducting polymer membrane comprising at least one polyazole, at least one ionic liquid and at least one compound of the formula (P1)
R^{I}₄POH (P1)
wherein R^{I}, in each case mutually independently, is a residue which comprises C, O and/or H optionally together with further atoms differing therefrom, wherein two residues R^{I} may optionally be joined to one another.

21. The proton-conducting polymer membrane according to claim 20, wherein the polyazole contains benzimidazole units of the formula 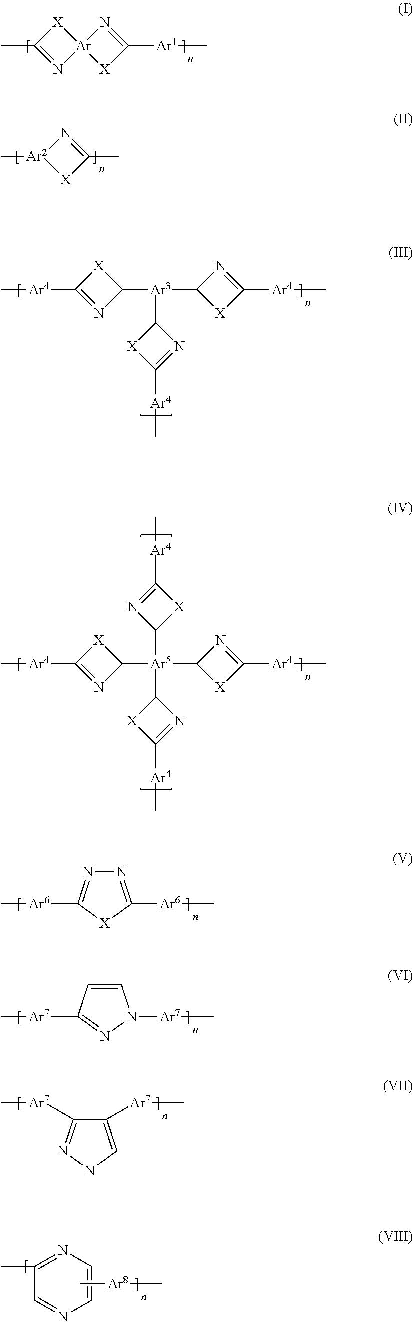 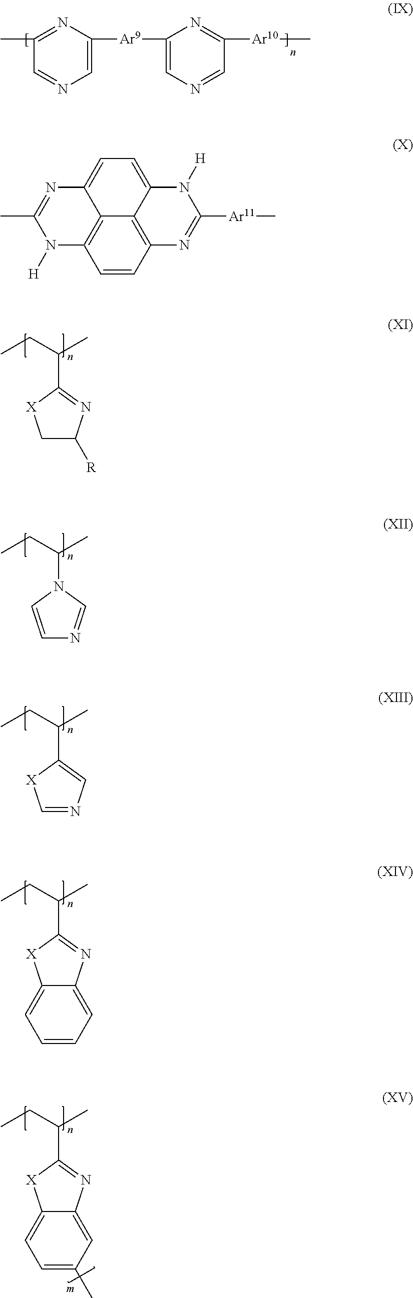 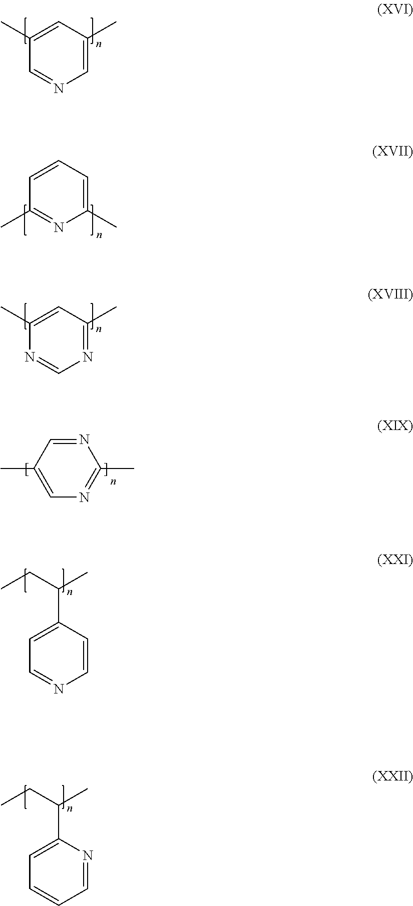
in which
Ar are identical or different and denote a tetravalent aromatic or heteroaromatic group, which may be mono- or polynuclear,
Ar¹ are identical or different and denote a divalent aromatic or heteroaromatic group, which may be mono- or polynuclear,
Ar² are identical or different and denote a di- or trivalent aromatic or heteroaromatic group, which may be mono- or polynuclear,
Ar³ are identical or different and denote a trivalent aromatic or heteroaromatic group, which may be mono- or polynuclear,
Ar⁴ are identical or different and denote a trivalent aromatic or heteroaromatic group, which may be mono- or polynuclear,
Ar⁵ are identical or different and denote a tetravalent aromatic or heteroaromatic group, which may be mono- or polynuclear,
Ar⁶ are identical or different and denote a divalent aromatic or heteroaromatic group, which may be mono- or polynuclear,
Ar⁷ are identical or different and denote a divalent aromatic or heteroaromatic group, which may be mono- or polynuclear,
Ar⁸ are identical or different and denote a trivalent aromatic or heteroaromatic group, which may be mono- or polynuclear,
Ar⁹ are identical or different and denote a di- or tri- or tetravalent aromatic or heteroaromatic group, which may be mono- or polynuclear,
Ar¹⁰ are identical or different and a di- or trivalent aromatic or heteroaromatic group, which may be mono- or polynuclear,
Ar¹¹ are identical or different and denote a divalent aromatic or heteroaromatic group, which may be mono- or polynuclear,
X is identical or different and denotes oxygen, sulfur or an amino group, which bears a hydrogen atom, a group comprising 1-20 carbon atoms,
R identically or differently denotes hydrogen, an alkyl group and an aromatic group and
n and m are identical or different and denote an integer greater than or equal to 10, 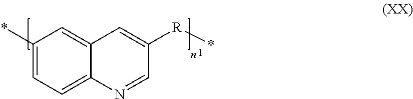
in which
R identically or differently denotes an alkyl group and an aromatic group and
n¹ is an integer greater than or equal to 10.

22. The proton-conducting polymer membrane according to claim 21, wherein X is identical or different and denotes oxygen, sulfur or an amino group, which bears a hydrogen atom, a group comprising 1-20 carbon atoms selected from a branched or unbranched alkyl or alkoxy group, or an aryl group as a further residue,
n and m are identical or different and denote an integer greater than or equal to 100, and
n¹ is an integer greater than or equal to 100.

23. The proton-conducting polymer membrane according to claim 20, wherein the membrane contains as ionic liquid (A), (B) or (C)
(A) salts of the formula (IL-I)
[A]ₙ⁺[Y]ⁿ⁻ (IL-I),
in which
n denotes 1, 2, 3 or 4,
[A]⁺ denotes a quaternary ammonium cation, an oxonium cation, a sulfonium cation or a phosphonium cation and
[Y]ⁿ⁻ denotes a mono-, di-, tri- or tetravalent anion;
(B) mixed salts of the formulas (IL-IIa), (IL-IIb) or (IL-IIc)
[A¹]⁺[A²]^{+[Y]}ⁿ⁻ (IL-IIa), wherein n=2;
[A¹]⁺[A²]⁺[A³]⁺[Y]ⁿ⁻ (IL-IIb), wherein n=3; or
[A¹]⁺[A²]⁺[A³]⁺[A⁴]⁺[Y]ⁿ⁻ (IL-IIc), wherein n=4 and
wherein [A¹]⁺, [A²]⁺, [A³]⁺ and [A⁴]⁺ are mutually independently selected from the groups stated for [A]⁺ and [Y]ⁿ⁻ has the meaning stated in (A); or
(C) mixed salts of the formulas (IL-IIIa), (IL-IIIb), (IL-IIIc), (IL-IIId), (IL-IIIe), (IL-IIIf), (IL-IIIg), (IL-IIIh), (IL-IIIi) or (IL-IIIj)
[A¹]⁺[A²]⁺[A³]⁺[M¹]⁺[Y]ⁿ⁻ (IL-IIIa), wherein n=4;
[A¹]⁺[A²]⁺[M¹]⁺[M²]⁺[Y]ⁿ⁻ (IL-IIIb), wherein n=4;
[A¹]⁺[M¹]⁺[M²]⁺[M³]⁺[Y]ⁿ⁻ (IL-IIIc), wherein n=4;
[A¹]⁺[A²]⁺[M¹]⁺[Y]ⁿ⁻ (IL-IIId), wherein n=3;
[A¹]⁺[M¹]⁺[M²]⁺[Y]ⁿ⁻ (IL-Ille), wherein n=3;
[A¹]⁺[M¹]⁺[Y]ⁿ⁻ (IL-IIIf), wherein n=2;
[A¹]⁺[A²]⁺[M⁴]²⁺[Y]ⁿ⁻ (IL-IIIg), wherein n=4;
[A¹]⁺[M¹]⁺[M⁴]²⁺[Y]ⁿ⁻ (IL-IIIh), wherein n=4;
[A¹]⁺[M⁵]³⁺[Y]ⁿ⁻ (IL-IIIi), wherein n=4; or
[A¹]⁺[M⁴]²⁺[Y]ⁿ⁻ (IL-IIIj), wherein n=3 and
wherein [A¹]⁺, [A²]⁺ and [A³]⁺ are mutually independently selected from the groups stated for [A]⁺, [Y]ⁿ⁻ has the meaning stated in (A) and [M¹]⁺, [M²]⁺, [M³]⁺ mean monovalent metal cations, [M⁴]²⁺ means divalent metal cations and [M⁵]³⁺ means trivalent metal cations.

24. The proton-conducting polymer membrane according to claim 20, wherein the ionic liquid has a melting point of less than 180° C.

25. The proton-conducting polymer membrane according to claim 20, wherein the ionic liquid comprises at least one cation which is selected from the group consisting of NH₄⁺, NH₃R⁺, NH₂R₃⁺, NHR₃⁺, NR₄⁺, 1-ethyl-2.3-dimethylimidazolium, P(OH)₄⁺, P(OR)₄⁺, and PR₄⁺ wherein R means methyl, ethyl, propyl or butyl.

26. The proton-conducting polymer membrane according to claim 20, wherein the ionic liquid comprises at least one anion which is selected from the group consisting of F⁻, BF₄⁻, PF₆⁻, CF₃SO₃⁻, (CF₃SO₃)₂N⁻, CF₃CO₂⁻, the group of sulfates, sulfites and sulfonates of the formula SO₄²⁻, HSO₄⁻, SO₃²⁻, HSO₃⁻, R^{a}OSO₃⁻, R^{a}SO₃⁻, from the group of phosphates of the formula PO₄³⁻, HPO₄²⁻, H₂PO₄⁻, R^{a}PO₄²⁻, from the group of borates of the formula BO₃³⁻, HBO₃²⁻, H₂BO₃⁻, from the group of silicates and silicic acid esters of the formula SiO₄⁴⁻, H₂SiO₄²⁻, H₃SiO₄⁻, of carboximides, bis(sulfonyl)imides, and sulfonylimides, and mixtures thereof.

27. The proton-conducting polymer membrane according to claim 20, wherein the membrane comprises at least one compound of the formula (P2), 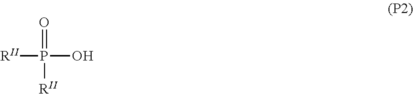
wherein R^{II} in each case mutually independently means a group comprising 1-20 carbon atoms or a residue OR^{V},
in which R^{V} means H, a group comprising 1-20 carbon atoms or a residue of the formula (P3) 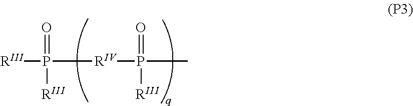
wherein
R^{III} in each case mutually independently means a group comprising 1-20 carbon atoms or a residue OR^{VI},
R^{IV} in each case mutually independently means O or a group comprising 1-20 carbon atoms,
R^{VI} in each case mutually independently means H or a group comprising 1-20 carbon atoms,
q means a number greater than or equal 1.

28. The proton-conducting polymer membrane according to claim 27, wherein the membrane comprises phosphoric acid, at least one phosphonic acid and/or polyphosphoric acid.

29. The proton-conducting polymer membrane according claim 20, wherein the membrane contains, in each case relative to the total weight thereof,
0.5 wt. % to 40.0 wt. % polyazole,
1.0 wt. % to 50.0 wt. % ionic liquid and
10.0 wt. % to 98.5 wt. % compound of the formula (P1).

30. The proton-conducting polymer membrane according to claim 20, wherein the polyazole and the ionic liquid are present in a weight ratio in the range from 1:2 to 1:100.

31. The proton-conducting polymer membrane according to claim 20, wherein the weight ratio of ionic liquid to compound of the formula (P1) is in the range from 1:1 to 1:20.

32. A method for producing the proton-conducting polymer membrane according to claim 20, comprising the steps
A) mixing one or more aromatic tetra-amino compounds with one or more aromatic carboxylic acids or the esters thereof, which contain at least two acid groups per carboxylic acid monomer, or mixing one or more aromatic and/or heteroaromatic diaminocarboxylic acids, in at least one compound of the formula (P1) or at least one compound which, on hydrolysis, yields at least one compound of the formula (P1), to form a solution and/or dispersion,
B) applying a layer using the mixture according to step A) onto a support,
C) heating the planar structure/layer obtainable according to step B) under inert gas to temperatures of up to 350° C. to form the polyazole polymer,
D) treating the membrane formed in step C) until it is self-supporting, wherein the ionic liquid is introduced into the membrane by
(i) already adding the ionic liquid to the solution or dispersion of step A) and carrying out the following steps B), C) and D) in the presence of the ionic liquid or
(ii) subsequently introducing the ionic liquid into the formed membrane.

33. The method according to claim 32, wherein the mixture of step A) is heated to temperatures of up to 350° C. such that it is possible partly or entirely to dispense with the heating in step C).

34. The method according to claim 32, wherein the mixture of step A) is heated to temperatures of up to 280° C., such that it is possible partly or entirely to dispense with the heating in step C).

35. The method according to claim 32, wherein step A) is carried out in polyphosphoric acid.

36. The method according to claim 32, wherein the membrane is firstly produced, then the compound of the formula (P1) is entirely or partially washed out and then the membrane is reimpregnated with a compound of the formula (P1) and the ionic liquid.

37. The method according to claim 32, wherein
in step A) at least one compound is used which, on hydrolysis, yields at least one compound of the formula (P1),
the membrane formed in step C) is treated in the presence of moisture at temperatures and for a duration which is sufficient for the membrane to be self-supporting, wherein hydrolysis is carried out using a composition which contains the ionic liquid.

38. An electrode with a proton-conducting polymer coating, comprising at least one polyazole, at least one ionic liquid and at least one compound of the formula (P1)
R^{I}₄POH (P1)
wherein R^{I}, in each case mutually independently, is a residue which comprises C, O and/or H optionally together with further atoms differing therefrom, wherein two residues R^{I} may optionally be joined to one another.

39. A membrane-electrode unit containing at least one electrode and at least one polymer membrane according to claim 20.

40. A fuel cell containing at least one membrane-electrode unit according to claim 39.
